(19) United States
(12) Patent Application Publication
(10) Pub. No.: US 2015/0130363 A1
(43) Pub. Date: May 14, 2015

(54) LED DRIVING DEVICE, LIGHTING DEVICE, AND CONTROL CIRCUIT FOR LED DRIVING DEVICE

(71) Applicant: SAMSUNG ELECTRONICS CO., LTD., Suwon-si (KR)

(72) Inventors: Bong Jin LEE, Hwaseong-si (KR); Kyu Cheol KANG, Suwon-si (KR)

(21) Appl. No.: 14/336,880

(22) Filed: Jul. 21, 2014

(30) Foreign Application Priority Data
Nov. 14, 2013 (KR) 10-2013-0138541

(51) Int. Cl. H05B 33/08

(52) U.S. Cl. CPC H05B 33/0809
USPC 315/201; 315/254

(57) ABSTRACT

A light emitting diode (LED) driving device includes a rectifier, a voltage converter, a variable impedance unit, and a controller. The rectifier rectifies an alternating current (AC) voltage to generate a first voltage. The voltage converter generates a second voltage for driving a plurality of LEDs from the first voltage. The variable impedance unit is connected to an input terminal of the rectifier. The controller adjusts impedance of the variable impedance unit based on at least one of the first and second voltages.

### CROSS-REFERENCE TO RELATED APPLICATION

This application claims the benefit of Korean Patent Application No. 10-2013-0138541 filed on Nov. 14, 2013, with the Korean Intellectual Property Office, the disclosure of which is incorporated herein by reference.

### BACKGROUND

The present disclosure relates to a light emitting diode (LED) driving device, a lighting device, and a control circuit for an LED driving device.

Light emitting diodes (LEDs) are commonly used as light sources because of various advantages they present such as low power consumption, high luminance, and the like. In particular, light emitting devices are employed as backlights in lighting devices and large liquid crystal displays (LCDs). In many cases, light emitting devices are provided in the form of a package configured to be easily installed in various devices such as lighting sockets, fixtures, and devices, or the like. As LEDs are being increasingly used for illumination purposes, the design of LEDs that can be used to replace existing lighting devices has emerged as an important issue.

### SUMMARY

An aspect of the present disclosure may provide a light emitting diode (LED) driving device allowing LED lighting to be applied without modification to equipment for operating an existing lighting fixture such as a fluorescent lamp or an incandescent lamp.

According to an aspect of the present disclosure, a light emitting diode (LED) driving device may include a rectifier, a voltage converter, a variable impedance unit, and a controller. The rectifier rectifies an alternating current (AC) voltage to generate a first voltage. The voltage converter generates a second voltage for driving a plurality of LEDs from the first voltage. The variable impedance unit is connected to an input terminal of the rectifier, and the controller adjusts impedance of the variable impedance unit based on at least one of the first and second voltages.

The controller may include a detecting circuit detecting at least one of the first voltage and the second voltage, a comparing circuit comparing the voltage detected by the detecting circuit with one or more reference voltages and adjusting the impedance of the variable impedance unit based on the comparison, and a delay circuit controlling an operation timing of an active element included in the comparing circuit.

The comparing circuit may include a first comparing circuit comparing the voltage detected by the detecting circuit with a first reference voltage, and a second comparing circuit comparing the voltage detected by the detecting circuit with a second reference voltage, wherein the first reference voltage is higher than the second reference voltage.

When the voltage detected by the detecting circuit is higher than the first reference voltage, the comparing circuit may adjust impedance of the variable impedance unit such that a level of the AC voltage is decreased, and when the voltage detected by the detecting circuit is lower than the second reference voltage, the comparing circuit may adjust the impedance of the variable impedance unit such that the level of the AC voltage is increased.

The first comparing circuit and the second comparing circuit may each include an operational amplifier, and the voltage detected by the detecting circuit may be applied to a non-inverting terminal of the operational amplifier included in the first comparing circuit and to an inverting terminal of the operational amplifier included in the second comparing circuit.

The delay circuit may delay an operation timing of the operational amplifiers included in the first and second comparing circuits by a predetermined duration.

A duration by which the delay circuit delays the operation timing of the operational amplifiers included in the first and second comparing circuits may be a duration taken for the operational amplifiers included in the first and second comparing circuits to start operating and outputting a voltage higher than the second reference voltage.

The first and second comparing circuits may each include a latch circuit connected to an output terminal of the operational amplifier of the corresponding comparing circuit.

The delay circuit may include one or more Schmitt Trigger circuits.

The variable impedance unit may include a capacitor bank having a plurality of capacitors connected in parallel.

When at least one of the first and second voltages is higher than the first reference voltage, the controller may control a capacitor having relatively large capacitance among the plurality of capacitors to be connected to the input terminals of the rectifier in parallel, and when at least one of the first and second voltages is lower than the second reference voltage lower than the first reference voltage, the controller may control a capacitor having relatively small capacitance among the plurality of capacitors to be connected to the input terminals of the rectifier in parallel.

The AC voltage may be generated by at least one of a transformer for halogen lamps and a stabilizer for fluorescent lamps.

The voltage converter may include a power factor correction (PFC) converter and a buck converter.

The controller may adjust impedance of the variable impedance unit based on detecting at least one of an input voltage and an output voltage of the PFC converter.

According to another aspect of the present disclosure, a lighting device may include a light emitting unit, an LED driver, a variable impedance unit, and a controller. The light emitting unit includes a plurality of light emitting diodes (LEDs). The LED driver drives the plurality of LEDs upon receiving an alternating current (AC) generated by at least one of a transformer for halogen lamp and a stabilizer for fluorescent lamp. The variable impedance unit is connected to an input terminal of the LED driver, and the controller adjusts a level of the AC voltage input to the LED driver by controlling impedance of the variable impedance unit.

The LED driver may include a rectifier rectifying the AC voltage to generate a first voltage, and a voltage converter generating a second voltage for driving the plurality of LEDs from the first voltage, wherein the variable impedance unit may be connected to an input terminal of the rectifier.

When at least one of the first and second voltages is outside of a predetermined voltage range, the controller may adjust the level of the AC voltage.

When at least one of the first and second voltages is lower than a lower limit level of the predetermined voltage range, the controller may adjust impedance of the variable impedance unit such that the level of the AC voltage is increased.

When at least one of the first and second voltages is higher than an upper limit level of the predetermined voltage range, the controller may adjust impedance of the variable impedance unit such that the level of the AC voltage is decreased.

The LED driver may adjust a magnitude of a current used for driving the plurality of LEDs based on a control command received via a wireless communications network.

According to another aspect of the present disclosure, a control circuit of a light emitting diode (LED) driving device driving a plurality of LEDs upon receiving an alternating current (AC) voltage may include a detecting circuit, a comparing circuit, and a delay circuit. The detecting circuit detects at least one of an input voltage and an output voltage of the LED driving device. The comparing circuit compares at least one of the input voltage and the output voltage of the LED driving device with a first reference voltage and a second reference voltage lower than the first reference voltage. The delay circuit delays an operation timing of an active element included in the comparing circuit.

The comparing circuit may include a first comparing circuit and a second comparing circuit. The first comparing circuit may have a first operational amplifier comparing at least one of the input voltage and the output voltage of the LED driving device with the first reference voltage and a latch circuit connected to an output terminal of the first operational amplifier. The second comparing circuit may have a second operational amplifier comparing at least one of the input voltage and the output voltage of the LED driving device with the second reference voltage and a latch circuit connected to an output terminal of the second operational amplifier.

When at least one of the input voltage and the output voltage of the LED driving device is higher than the first reference voltage, the comparing circuit may decrease a level of the AC voltage, and when at least one of the input voltage and the output voltage of the LED driving device is lower than the second reference voltage, the comparing circuit may increase the level of the AC voltage.

The comparing circuit may increase or decrease the level of the AC voltage by adjusting a capacitance value of a capacitor bank included in the LED driving device.

According to another aspect of the present disclosure, a method for controlling a lighting system includes rectifying an alternating current (AC) voltage to generate a direct current (DC) voltage using a rectifier circuit. The generated DC voltage is converted into a voltage or current used to drive the lighting system using a voltage converter coupled to outputs of the rectifier circuit. An amplitude of at least one of the generated DC voltage and the voltage output by the rectifier circuit is measured, and an impedance value of a variable impedance unit coupled to an input of the rectifier circuit is adjusted based on the measured voltage to control the amplitude of the voltage or current used to drive the lighting system.

The method may further include setting lighting characteristics for a plurality of different temperature or humidity ranges, measuring a temperature or humidity, determining a lighting characteristic corresponding to the measured temperature or humidity according to the set lighting characteristics, and controlling the lighting system to emit light having the determined lighting characteristic by adjusting the impedance value of the variable impedance unit to control the amplitude of the voltage or current used to drive the lighting system.

The method may further include detecting a motion, controlling an illumination intensity sensor in response to detecting the motion to measure an intensity of illumination, determining a range of illumination intensity values among a plurality of ranges of illumination intensity values including the measured intensity of illumination, and controlling the lighting system to emit light having a lighting characteristic associated with the determined range of illumination intensity values by adjusting the impedance value of the variable impedance unit to control the amplitude of the voltage or current used to drive the lighting system.

The method may further include wirelessly transmitting a sensing signal including the measured intensity of illumination, and receiving the wirelessly transmitted sensing signal, wherein the determining and controlling steps are performed with respect to the measured intensity of illumination that is retrieved from the received sensing signal.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram schematically illustrating a lighting device according to an exemplary embodiment of the present disclosure;

FIG. 2 is an equivalent circuit diagram illustrating an operation of an electronic transformer included in the lighting device according to an exemplary embodiment of the present disclosure;

FIGS. 3 and 4 are graphs showing voltage gain curves of the equivalent circuit diagram illustrated in FIG. 2;

FIGS. 5 through 8 are block diagrams schematically illustrating an LED driving device according to various exemplary embodiments of the present disclosure;

FIG. 9 is a circuit diagram illustrating an LED driving device according to an exemplary embodiment of the present disclosure;

FIGS. 10 through 12 are graphs illustrating operations of an LED driving device according to an exemplary embodiment of the present disclosure;

FIG. 13 is a block diagram schematically illustrating a lighting system according to an exemplary embodiment of the present disclosure;

FIG. 14 is a block diagram schematically illustrating a detailed configuration of a light emitting unit of the lighting system illustrated in FIG. 13;

FIG. 15 is a flow chart illustrating a method for controlling the lighting system illustrated in FIG. 13;

FIG. 16 is a view schematically illustrating the way in which the lighting system illustrated in FIG. 13 is used;

FIG. 17 is a block diagram of a lighting system according to another exemplary embodiment of the present disclosure;

FIG. 18 is a view illustrating a format of a wireless signal employable in a lighting system according to an exemplary embodiment of the present disclosure;

FIG. 19 is a view illustrating a sensing signal analyzing unit and an operation controller according to an exemplary embodiment of the present disclosure;

FIG. 20 is a flow chart illustrating an operation of a wireless lighting system according to an exemplary embodiment of the present disclosure;

FIG. 21 is a block diagram schematically illustrating components of a lighting system according to an exemplary embodiment of the present disclosure;

FIGS. 22 through 24 are flow charts illustrating methods for controlling a lighting system according to various exemplary embodiments of the present disclosure;

FIGS. 25 through 27 are views illustrating structures of a lighting device according to exemplary embodiments of the present disclosure.

### DETAILED DESCRIPTION

Hereinafter, exemplary embodiments of the present disclosure will be described in detail with reference to the accompanying drawings.

The disclosure may, however, be exemplified in many different forms and should not be construed as being limited to the specific exemplary embodiments set forth herein. Rather, these exemplary embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

FIG. 1 is a block diagram schematically illustrating a lighting device according to an exemplary embodiment of the present disclosure.

Referring to FIG. 1, a lighting device 10 includes an alternating current (AC) power source 11, a dimmer 12, a transformer 13, a light emitting diode (LED) driving device 14, and a light emitting unit 15.

The light emitting unit 15 may include a plurality of LEDs connected in series or parallel. The AC power source may be a commercial AC power source, and may be, for example, a 220V AC power source.

The dimmer 12 may be connected between the AC power source 11 and the transformer 13, and may be used to control brightness of light output by the light emitting unit 15 by controlling a phase of AC power in a trailing edge or leading edge manner. The transformer 13 may be a magnetic or electronic transformer, and if a halogen lamp is connected to an output terminal of the transformer 13, the transformer 13 may perform an operation of turning the halogen lamp on. In FIG. 1, the lighting device 10 is illustrated as including a transformer 13 configured for use with a halogen lamp, but a stabilizer for fluorescent lamp may alternatively be connected between the dimmer 12 and the LED driving device 14.

In a case in which the transformer 13 is a magnetic transformer, the transformer 13 may be configured such that a primary coil and a secondary coil are wound in a core thereof. The primary coil may be connected to the AC power source 11 and a ratio between a number of turns of the primary coil and a number of turns of the secondary coil may be determined such that 12V AC power may be output from the secondary coil.

In a case in which the transformer 13 is an electronic transformer, the transformer 13 may include an electromagnetic interference (EMI) filter, a full-wave rectifying circuit, a half-bridge inverter circuit, an output terminal transformer, and the like. When AC power is applied from the AC power source 11, the AC power may pass through the EMI filter, the full-wave rectifying circuit converting the AC power into a DC power, and the half-bridge inverter converting the DC power into AC power. The half-bridge inverter may include a plurality of switches, an inductor, and a capacitor. The electronic transformer may also be divided into a self-oscillation transformer and an external-oscillation transformer according to a way in which a plurality of switches are driven. The self-oscillation transformer may generate a switch driving signal by using a pulse transformer as a passive element without an integrated circuit (IC) and the external-oscillation transformer may generate a switch driving signal by using an IC.

An LC resonance tank including an inductor and a DC link capacitor may be connected to an output terminal of the half-bridge inverter converting DC power into AC power, and the LED driving device 14 may be connected to the output terminal of the LC resonance tank. Unlike a halogen lamp that is used as a resistive load and has a predetermined impedance, the impedance of a light emitting unit 15 including a plurality of LEDs and the impedance of an LED driving device controlling an operation of the light emitting unit 15 may vary according to a topology of a circuit and an operational frequency, a duty ratio, and the like of a switch included in the circuit. Thus, due to a change in input impedance of the LED driving device 14, it may be difficult to control impedance matching and constant current supply merely by controlling an operational frequency and a duty ratio of a switch included in the LED driving device 14. In an exemplary embodiment of the present disclosure, a variable impedance unit is disposed in an input terminal of the LED driving device 14 connected to an output terminal of the transformer 13. The variable impedance unit can be used to adjust a magnitude of a voltage delivered to the LED driving device 14.

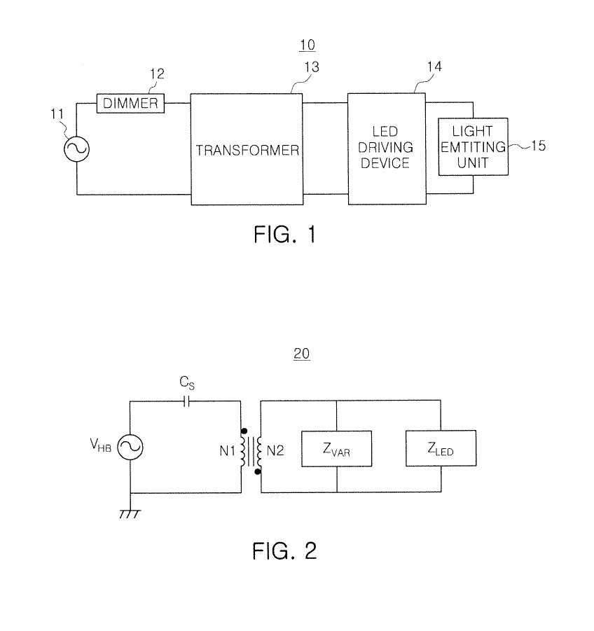

FIG. 2 is an equivalent circuit diagram illustrating an operation of a transformer included in the lighting device according to an exemplary embodiment of the present disclosure.

An equivalent circuit diagram 20 in FIG. 2 illustrates an operation of the transformer 13 in the lighting device 10 illustrated in FIG. 1. In the embodiment of FIG. 2, the transformer is assumed to be an electronic transformer. AC power V_{HB} output from a half-bridge inverter included in the electronic transformer may be applied to the primary coil N1 through a capacitor CS included in an LC resonance tank. A voltage applied across both ends of the primary coil N1 may be reduced according to the ratio between the numbers of turns of the primary and secondary coils N1 and N2, and induced across both ends of the secondary coil N2. An impedance Z_{LED} of the LED driving device 14 and the light emitting unit 15 and an impedance Z_{VAR} of the variable impedance unit prepared in an input terminal of the LED driving device 14 may be connected in parallel to both ends of the secondary coil.

Impedance of the secondary side is reflected in the primary coil N1 according to the ratio between the numbers of turns, and may be expressed by Equation 1 below. In Equation 1, N is the ratio between numbers of turns of the primary coil N1 and the secondary coil N2 (N=N1/N2), and Z_{EQ} is equivalent impedance viewed from the primary side.

$${Z}_{EQ} = \frac{( {Z}_{VAR} // {Z}_{LED} )}{{N}^{2}} \qquad [ Equation 1 ]$$

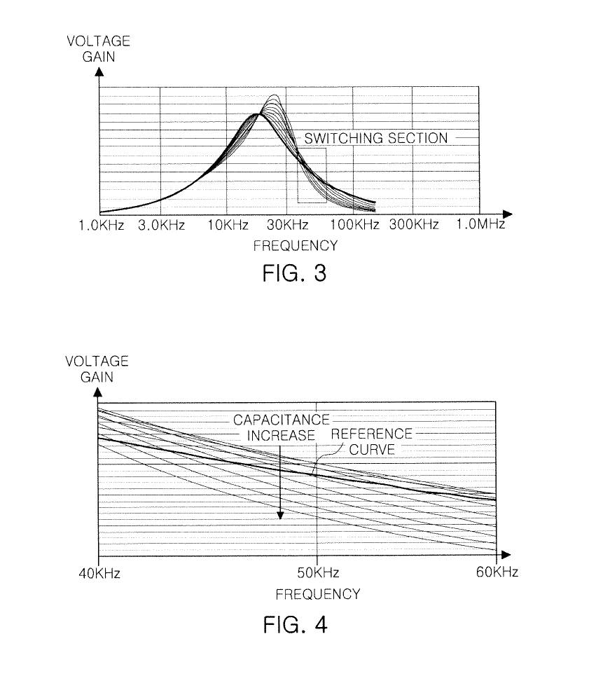

As can be seen in Equation 1, when the impedance Z_{VAR} of the variable impedance unit is changed, the equivalent impedance Z_{EQ} of the secondary side viewed from the primary side is changed; as a result, a voltage gain at the output terminal of the transformer may be changed. The variable impedance unit (having impedance Z_{VAR}) may include various types of elements such as a capacitor bank, a variable inductor, a temperature control element, a switch element, and the like. In a case in which the variable impedance unit is a capacitor bank, a change in a voltage gain of the transformer according to a change in a capacitance value may appear as shown in the graphs of FIGS. 3 and 4. This will be described with reference to FIGS. 3 and 4, hereinafter.

FIGS. 3 and 4 are graphs illustrating voltage gain curves of the equivalent circuit diagram illustrated in FIG. 2.

Referring to FIG. 3, the X axis represents a driving frequency of the transformer 13, and the Y axis represents a voltage gain. A plurality of voltage gain curves denoting different trends may result from a change in a capacitance value of the variable impedance unit implemented as a capacitor bank. In FIG. 3, it is illustrated that the voltage gain has a maximum value when a driving frequency of the transformer 13 ranges from 10 kHz to 30 kHz. Considering the fact that a driving frequency of the transformer 13 generally is within a range from 40 kHz to 60 kHz (and is, in particular, generally at approximately 50 kHz), a voltage gain of the transformer 13 has a tendency to vary (e.g., to be increased or decreased) as a result of changes in capacitance at the driving frequency (e.g., a frequency of approximately 50 kHz).

FIG. 4 is an enlarged graph showing changes in voltage gain curves over a change in a capacitance value of the variable impedance unit when the driving frequency of the transformer 13 ranges from 40 kHz to 60 kHz. Referring to FIG. 4, it can be seen that when the variable impedance unit is connected to the input terminal of the LED driving device and has a small capacitance value (see, e.g., the upper curves of FIG. 4), the voltage gain is higher than in a situation in which the variable impedance unit is not connected (e.g., the reference curve shown in FIG. 4). Conversely, when the variable impedance unit has a large capacitance value and is connected to the input terminal of the LED driving device 14 (see, e.g., the lower curves of FIG. 4), the voltage gain is decreased.

In a case in which the variable impedance includes a capacitor bank and is connected to the input terminal of the LED driving device 14 in parallel, since the capacitor bank supplies a current having a phase 90-degrees earlier than a voltage, a power factor improvement effect may be obtained in a load side of the transformer 13. Thus, by connecting a capacitor bank having an appropriate size to the input terminal of the LED driving device 14 in order to improve voltage fluctuation, a voltage gain may be increased. Conversely, a voltage gain may be controlled to be lowered by connecting a capacitor bank having large capacitance to the input terminal of the LED driving device 14.

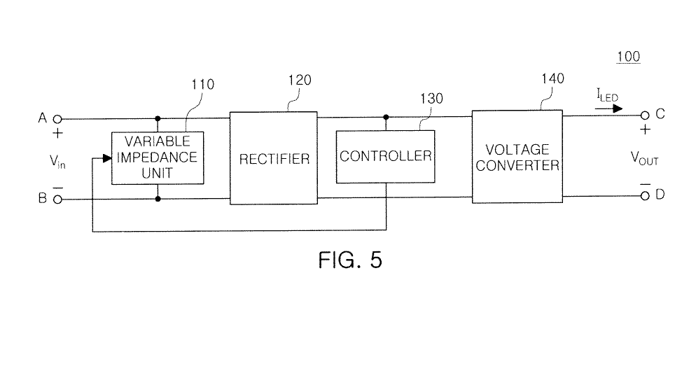

FIGS. 5 through 8 are block diagrams schematically illustrating an LED driving device (or LED driver) according to an exemplary embodiment of the present disclosure.

Referring to FIG. 5, an LED driving device 100 according to the present exemplary embodiment may include a variable impedance unit 110, a rectifier 120, a controller 130, and a voltage converter 140. The rectifier 120 may be configured as a general diode bridge converting an AC voltage into a DC voltage, and a variable impedance unit 110 may be connected between input terminals A and B of the LED driving device 100 and the rectifier 120. The variable impedance unit 110 may include a capacitor bank, a variable inductor, a temperature control element, a switch element, and the like, and an impedance value of the variable impedance unit 110 may be adjustably determined by the controller 130.

In FIG. 5, the controller 130 may adjustably determine the impedance value of the variable impedance unit 110 based on detecting a value of an input voltage of the voltage converter 140. Also, in a different exemplary embodiment, the controller 130 may determine the impedance of the variable impedance unit 110 based on detecting a value of an output voltage of the voltage converter 140, or by detecting both an input voltage value and an output voltage value of the voltage converter 140.

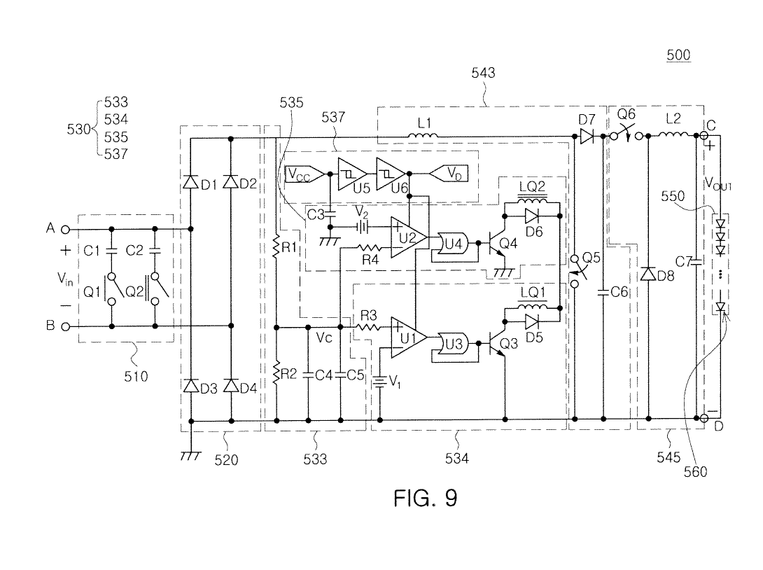

The controller 130 may include a detecting circuit detecting at least one of an input voltage and an output voltage of the voltage converter 140, a comparing circuit comparing the voltage detected by the detecting circuit with a predetermined reference voltage to determine a value to which the impedance of the variable impedance unit 110 should be adjusted, and the like. Also, optionally, the controller 130 may include a delay circuit delaying an operation of the comparing circuit by a predetermined duration, and the delay circuit may prevent malfunction of the LED driving device 100 caused by the controller 130. Details of the operation of the delay circuit will be described with reference to the circuit diagram of FIG. 9 hereinbelow.

The voltage converter 140 may include a single converter or a plurality of converters. In a case in which the voltage converter 140 includes a single converter, the voltage converter 140 may include a buck converter converting DC power generated by the rectifier 120 and applied to the input of the voltage converter 140 to power V_{OUT} and I_{LED} appropriate for driving a light emitting unit connected to the output of the voltage converter 140. Meanwhile, in a case in which the voltage converter 140 includes a plurality of converters, the voltage converter 140 may include one or more of a PFC converter, a buck converter, and the like, sequentially connected between the rectifier 120 and output terminals C and D of the LED driving device 100.

In the exemplary embodiment in which the voltage converter 140 includes a single buck converter, since an input voltage of the buck converter is higher than an output voltage thereof, the controller 130 may cause an increase in a voltage gain of the transformer 13 delivering power to the input terminals A and B of the LED driving device 100 by adjusting the impedance of the variable impedance unit 110. For example, in a case in which the variable impedance unit 110 includes a capacitor bank, when a magnitude of a voltage Vin delivered to the input terminals A and B is lower than a predetermined reference voltage (or when an input voltage or output voltage of the voltage converter 140 is lower than a predetermined reference voltage), the controller 130 may control the variable impedance unit 110 to enable a capacitor having a small capacitance value to be connected between the input terminals A and B, thus increasing a voltage gain of the transformer 13.

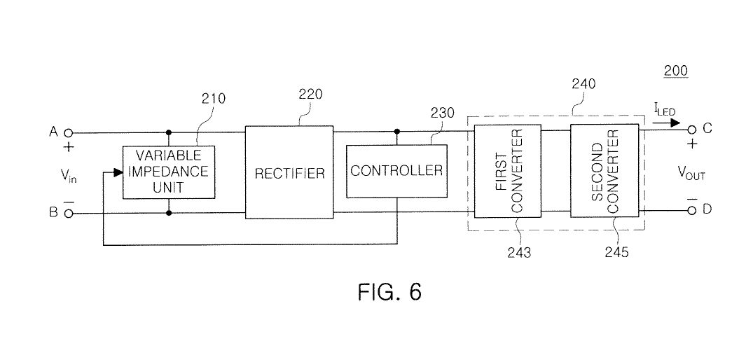

Referring to FIG. 6, an LED driving device 200 receives an AC voltage Vin through input terminals A and B, and the input voltage Vin may be input to a rectifier 220 through a variable impedance unit 210 having an impedance that is adjusted by a controller 230. The rectifier 220 converts the AC voltage Vin into a DC voltage and delivers the converted DC voltage to a voltage converter 240. In the present exemplary embodiment, the voltage converter 240 may include a first converter 243 and a second converter 245 connected in series. The first converter 243 may be a PFC converter, and the second converter 245 may be a buck converter.

The controller 230 may detect an input voltage of the first converter 243, compare the detected input voltage with a predetermined reference voltage, and adjustably set an impedance value of the variable impedance unit 210 based on the comparison result. In an exemplary embodiment, the controller 230 may compare the input voltage with a first reference voltage and a second reference voltage and determine an impedance value of the variable impedance unit 210 based on the comparison results. In this case, the first reference voltage and the second reference voltage may be voltages having different levels. Hereinafter, for the purposes of description, it is assumed that the first reference voltage has a level higher than that of the second reference voltage.

In the present exemplary embodiment, the voltage converter 240 includes a plurality of converters 243 and 245, and in particular, since the first converter 243 is a PFC converter, the input voltage of the first converter 243 may be limited to a predetermined range in order to control an output voltage of the first converter 243 to have a predetermined level. Thus, impedance of the variable impedance unit 210 can be determined and set such that when a level of the voltage Vin applied to the input terminals A and B of the LED driving device 200 is higher than that of the first reference voltage, a voltage gain of the transformer 13 connected to the input terminals A and B is lowered, and conversely, when the level of voltage Vin is lower than the second reference voltage, the voltage gain of the transformer 13 is raised.

For example, in a case in which the variable impedance unit 210 includes a capacitor bank, the controller 230 may adjust a voltage gain of the transformer 13 that supplies the voltage Vin to the input terminals A and B by connecting capacitors having different capacitance values in the variable impedance unit 210 coupled between the input terminals A and B. When the input voltage of the first converter 243 is higher than the first reference voltage, the controller 230 may reduce the voltage gain of the transformer 13 by controlling the variable impedance unit 210 such that a capacitor having a relatively high capacitance value is connected between the input terminals A and B. Conversely, when the input voltage of the first converter 243 is lower than the second reference voltage, the controller 230 may increase the voltage gain of the transformer 13 by controlling the variable impedance unit 210 such that a capacitor having a relatively low capacitance value is connected between the input terminals A and B. When the input voltage of the first converter 243 is lower than the first reference voltage and higher than the second reference voltage, the controller 230 may not control variable impedance unit 210.

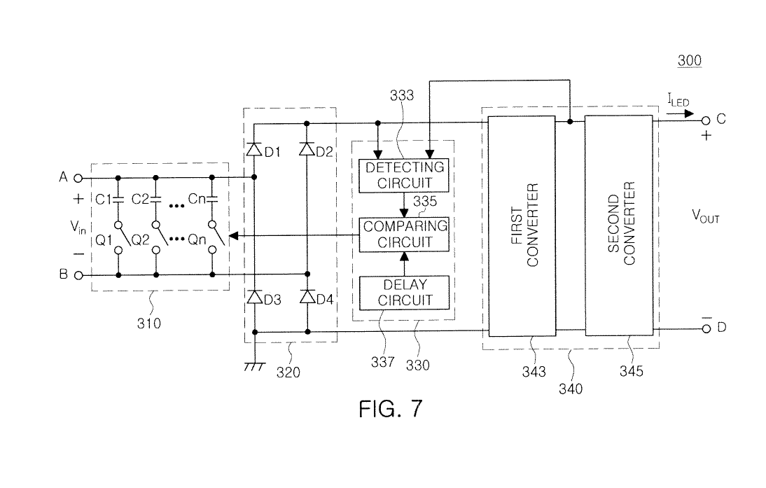

Referring to FIG. 7, the LED driving device 300 may receive an AC voltage Vin from the transformer 13 through the input terminals A and B, and the AC voltage Vin may be applied to a rectifier 320 through a capacitor bank 310 having a capacitance value that is controlled by a controller 330. The rectifier 320 converts the AC voltage Vin into a DC voltage and delivers the DC voltage to a voltage converter 340. The voltage converter 340 may include a first converter 343 and a second converter 345. Similar to the exemplary embodiment of FIG. 6, the first converter 343 may be a PFC converter, and the second converter 345 may be a buck converter.

In the present exemplary embodiment, the controller 330, controlling a capacitance value of the capacitor bank 310 may include a detecting circuit 333, a comparing circuit 335, and a delay circuit 337. The detecting circuit 333 detects at least one of an input voltage and an output voltage of the first converter 343 and delivers the detected voltage to the comparing circuit 335. The comparing circuit 335 compares the detected voltage with predetermined first and second reference voltages to determine to which a capacitance value of the capacitor bank 310 should be adjustably set. The delay circuit 337 may delay an operation timing of an active element included in the comparing circuit 335 by a predetermined duration to prevent malfunction of the LED driving device 300 due to the controller 330 and the capacitor bank 310.

The capacitor bank 310 may include switching elements Q1, Q2, . . . , Qn and capacitors C1, C2, . . . , Cn. Each of the switching elements may be connected in series with a corresponding capacitor, and the interconnections of switching elements Q1, Q2, . . . , Qn and capacitors C1, C2, . . . , Cn may be connected in parallel with each other. The capacitors C1, C2, . . . , Cn may have different capacitance values, and on/off operations of the switching elements Q1, Q2, Qn may be controlled by the comparing circuit 335 of the controller 330. The on/off operation of the switching elements Q1, Q2, . . . , Qn may adjustably connect or disconnect different ones of the capacitors C1, C2, . . . , Cn in parallel with each other.

Under the assumption that the capacitors C1, C2, . . . , Cn have capacitance values increased in a direction toward Cn (e.g., C1<C2< . . . <Cn), if an input voltage of the first converter 343 is lower than the second reference voltage, the controller 330 may turn on the switching element Q1 (e.g., while leaving the remaining switching elements Q2-Qn turned off) in order to connect a capacitor having a smaller capacitance value, such as the capacitor C1. In a case in which the input voltage of the first converter 343 is higher than the first reference voltage, the controller 330 may turn on the switching element Qn in order to connect a capacitor having a greater capacitance value, such as the capacitor Cn. As a result, the capacitors connected between the input terminals A and B may be selectively determined according to how much lower the input voltage of the first converter 343 is compared to the second reference voltage or how much higher the input voltage of the first converter 343 is compared to the first reference voltage.

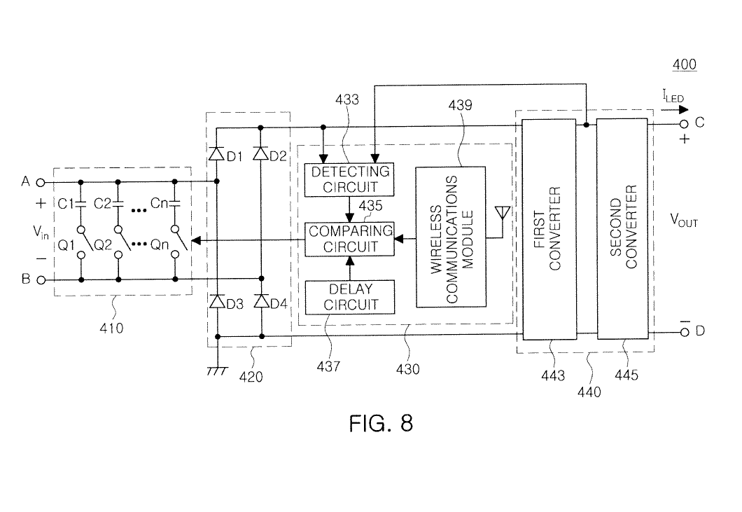

Referring to FIG. 8, an LED driving device 400 receives an AC voltage Vin from the transformer 13 through input terminals A and B, and the AC voltage may be converted into a DC voltage by a rectifier 420 so as to be delivered to a voltage converter 440. The voltage converter 440 may generate an output voltage V_{OUT} and a current I_{LED} for driving a plurality of LEDs by using the converted DC voltage from the rectifier 420. Similar to the exemplary embodiment of FIG. 7, a capacitor bank 410 may be connected between the rectifier 420 and the input terminals A and B, and on/off operations of switching elements Q1, Q2, . . . , Qn included in the capacitor bank 410 may be controlled by a controller 430.

The controller 430 may include a detecting circuit 433 detecting at least one of an input voltage and an output voltage of the first converter 433, a comparing circuit 435 comparing the voltage detected by the detecting circuit 433 with first and second reference voltages, a delay circuit 437 controlling an operation timing of an active element included in the comparing circuit 435, and a wireless communications module 439. The wireless communications module 439 may be connected to a separately provided wireless controller via a wireless communications network such as ZigBee™, Bluetooth™, infrared communication (or IrDA (Infrared Data Association)), Wi-Fi, ultra-wide band (UWB), or the like. Brightness of light output by a light emitting unit 15 connected to the output of the voltage converter 440 may be controlled by the wireless controller through the wireless communications module 439, and, in particular, a lighting device may be wirelessly controlled by the wireless controller regardless of control through the dimmer 12 (e.g., as shown in FIG. 1). Brightness of light output by the light emitting unit 15 may be controlled by adjusting a magnitude of the current I_{LED} input to the light emitting unit 15 from the voltage converter 440 according to a control command delivered from the wireless controller through the wireless communications module 439.

In particular, with the command delivered from the wireless controller through the wireless communications module 439, brightness of light output by the light emitting unit 15 may be controlled by adjusting a capacitance value of the capacitor bank 410 rather than by controlling a phase of an AC voltage by a dimmer. As a result, since a voltage gain of the transformer 13 connected to the input terminals A and B is adjusted by changing a capacitance value of the capacitor bank 410 through the wireless communications module 439, brightness of light output by the light emitting unit 15 may be adjusted through wireless controlling even though the dimmer 12 is set to provide the maximum brightness.

FIG. 9 is a circuit diagram illustrating an LED driving device according to an exemplary embodiment of the present disclosure.

Referring to FIG. 9, an LED driving device 500 according to the present exemplary embodiment may include input terminals A and B to which an AC voltage Vin is applied from the transformer 13, a capacitor bank 510 connected between the input terminals A and B, a rectifier 520, a controller 530, a first converter 543, and a second converter 545. A light emitting unit 550 including a plurality of LEDs 560 may be connected to output terminals C and D of the second converter 545.

The capacitor bank 510 is illustrated as including only two capacitors C1 and C2 and two switching elements Q1 and Q2 for description purposes, but larger numbers of capacitors (e.g., C1-Cn) and switching elements (e.g., Q1-Qn) may be provided. The capacitor C1 has a capacitance value greater than that of the capacitor C2 (e.g., C1>C2), and on/off operations of the switching elements Q1 and Q2 may be controlled by a current flowing in inductors LQ1 and LQ2 included in the controller 530.

Similar to the exemplary embodiments of FIGS. 7 and 8, the rectifier 520 may include a diode bridge circuit. Diodes D1 to D4 included in the rectifier 520 may full-wave rectify the voltage Vin output by the transformer 13 to convert it into a DC voltage including a ripple component. In order to provide a fast switching rate, the rectifier 520 may be implemented as a Schottky diode.

The full-wave rectified DC voltage from the rectifier 520 may be delivered to the first converter 543 including an inductor L1, a switching element Q5, a diode D7, and a capacitor C6. The first converter 543 may be a PFC converter. In operation, while the switching element Q5 is turned off, the capacitor C6 may be charged by the full-wave rectified DC voltage. While the switching element Q5 is turned on, the electric charges charged in the capacitor C6 may be delivered to the second converter 545 through a turned-on switching element Q6.

The second converter 545 may be a buck converter including a switching element Q6, an inductor L2, a diode D8, and a capacitor C7. The light emitting unit 550 including a plurality of LEDs 560 may be connected to the capacitor C7 in parallel. When the switching element Q6 is turned on, electric charges charged in the capacitor C6 may be supplied through the inductor L2, and when the switching element Q6 is turned off, energy excited by the inductor L2 may be supplied to the light emitting unit 550 to allow the plurality of LEDs 560 to emit light. An output voltage V_{OUT} from the second converter 545 operating as a buck converter may be determined by a duty ratio of the switching element Q6.

Hereinafter, operations of the controller 530 and the capacitor bank 510 of the LED driving device 500 illustrated in FIG. 9 will be described. In FIG. 9, it is illustrated that the detecting circuit 533 of the controller 530 detects an input voltage of the first converter 543, but the detecting circuit 533 may also (or alternatively) detect an output voltage of the first converter 543.

The detecting circuit 533 may include resistors R1 and R2 and capacitors C4 and C5. Noise of the input voltage of the first converter 543 distributed by the series connected resistors R1 and R2 may be canceled by the capacitor C4, and electric charges may be charged in the capacitor C5. Namely, the detecting circuit 533 generates a voltage V_{C} across the capacitor C5 by detecting the input voltage of the first converter 543.

The voltage V_{C} may be input to the first comparing circuit 534 and the second comparing circuit 535. Referring to FIG. 9, the first and second comparing circuits 534 and 535 may include operational amplifiers U1 and U2, respectively, and the voltage V_{C} may be input to a non-inverting terminal of the operational amplifier U1 included in the first comparing circuit 534 and an inverting-terminal of the operational amplifier U2 included in the second comparing circuit 535. A first reference voltage V₁ may be applied to an inverting terminal of the operational amplifier U1, and a second reference voltage V₂ may be applied to a non-inverting terminal of the operational amplifier U2.

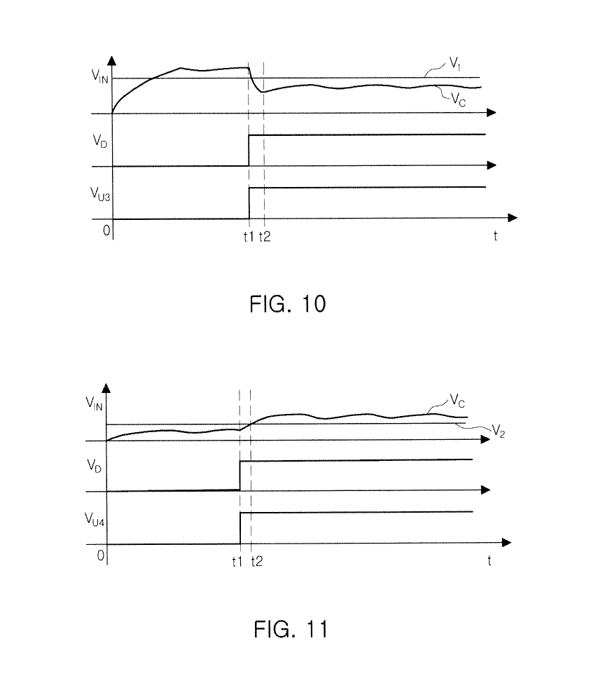

Latch circuits including OR gates U3 and U4 may be connected to output terminals of the operational amplifiers U1 and U2, respectively. In a case in which the voltage V_{C} is higher than the first reference voltage or lower than the second reference voltage V2 such that an adjustment may be made to the capacitor bank 510, the switching elements Q1 and Q2 included in the capacitor bank 510 may be repeatedly turned on and off. This malfunction may be prevented by the latch circuits. Details of operations of the latch circuits will be hereinafter described with reference to FIGS. 10 and 11.

In a case in which the voltage V_{C} is lower than the first reference voltage V₁ and higher than the second reference voltage V₂, that is, in a case in which the voltage V_{C} is within an appropriate level range, both of the operational amplifiers U1 and U2 may output LOW signals. Accordingly, both the OR gates U3 and U4 included in the latch circuits may not operate, and since a current does not flow in either of the inductors LQ1 and LQ2, both the switching elements Q1 and Q2 of the capacitor bank 510 may be maintained in a turned-off state.

The voltage V_{C} may be higher than the first reference voltage V₁ when the voltage Vin having an excessively high level is generated by the transformer 13 and applied to the LED driving device 500. In this case, the operational amplifier U2 included in the second comparing unit 535 may output a LOW signal, while the operational amplifier U1 included in the first comparing circuit 534 may output a HIGH signal. Accordingly, an OR gate U3 connected to an output terminal of the operational amplifier U1 may output a HIGH signal, and the switching element Q3 may be turned on to allow a current to flow to the inductor LQ1; thus, the switching element Q1 of the capacitor bank 510 may be turned on.

Namely, among the capacitors C1 and C2 included in the capacitor bank 510, the capacitor C1 having a relatively high capacitance value may be connected between the input terminals A and B of the LED driving device 500. Thus, a voltage gain of the transformer 13 may be reduced to reduce a level of the AC voltage Vin. In this case, as the AC voltage Vin is reduced, the voltage V_{C} applied to the non-inverting terminal of the operational amplifier U1 may be reduced to be lower than the first reference voltage V₁, and accordingly, the output signal from the operational amplifier U1 may be changed from HIGH to LOW. Even after the output signal from the operational amplifier U1 is changed to the LOW, the OR gate U3 may receive feedback of its output to keep outputting the HIGH signal; as a result, the switching element Q3 may be kept to be turned on to continuously apply a current to the inductor LQ1 to allow the switching element Q2 of the capacitor bank 510 to be maintained in the turned-on state.

Alternatively, the voltage V_{C} may be lower than the second reference voltage V₂ when a voltage Vin having a low level is generated by the transformer 13 and applied to the LED driving device 500. In this case, the operational amplifier U1 included in the first comparing circuit 534 may output a LOW signal, while the operational amplifier U2 included in the second comparing circuit 535 may output a HIGH signal. Accordingly, an OR gate U4 connected to an output terminal of the operational amplifier U2 may output a HIGH signal, and the switching element Q4 may be turned on to allow a current to flow to the inductor LQ2; thus, the switching element Q2 of the capacitor bank 510 may be turned on.

Since the capacitor C2 having a relatively low capacitance value is connected between the input terminals A and B, a voltage gain of the transformer 13 may be increased, and as a result, the AC voltage Vin may be increased. The increase in the AC voltage Vin may increase the voltage V_{C} input to a non-inverting terminal of the operational amplifier U2 to be higher than the second reference voltage V₂, thus changing the output signal from the operational amplifier U2 from HIGH to LOW. The LOW signal may be delivered even to an input terminal of the OR gate U4; however, since the output signal from the OR gate U4 is fed back to be delivered to the other input terminal of the OR gate U4, the HIGH signal may be input. Thus, the switching element Q4 may be maintained in the turned-on state and a current may continuously flow to the inductor LQ2, whereby the connection state of the capacitor C1 may be maintained.

The controller 530 may further include a delay circuit 537 in addition to the detection circuit 533 and the first and second comparing circuits 534 and 535. The delay circuit 537 may include a capacitor C3 and operational amplifiers U5 and U6 operating as comparators. For example, the operational amplifiers U5 and U6 may operate as Schmitt trigger circuits.

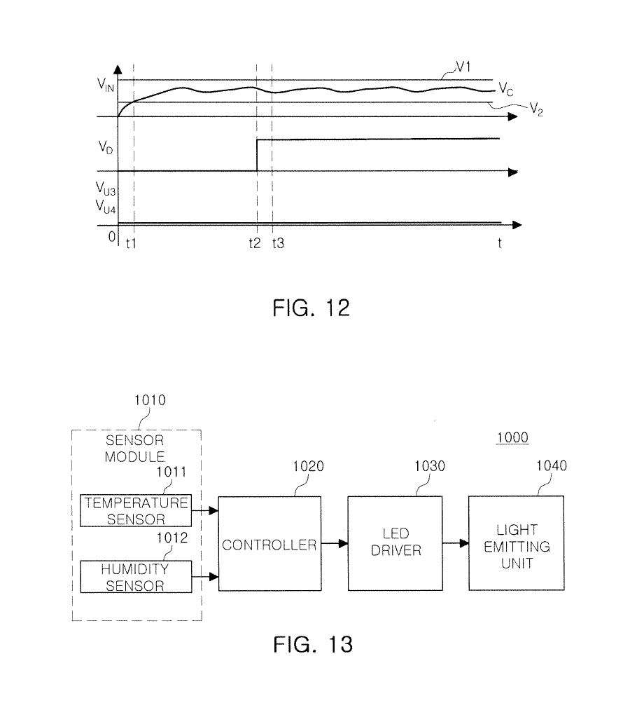

The capacitor C3 may be charged by the supply voltage V_{CC}, and until the voltage of the capacitor C3 reaches a reference voltage of the operational amplifiers U5 and U6 operating as Schmitt trigger circuits, the operational amplifiers U5 and U6 may output a LOW signal. When electric charges are sufficiently charged in the capacitor C3 and a voltage of the capacitor C3 reaches the reference voltage of the Schmitt trigger circuits, the output signals from the operational amplifiers U5 and U6 may be changed to HIGH such that driving signals may be supplied to the operational amplifiers U1 and U2 of the first and second comparing circuits 534 and 535. Namely, a delay time of driving start timing of the operational amplifiers U1 and U2 may be determined by a magnitude of the capacitor C3, whereby malfunction of the LED driving device 500 may be prevented. Details of operations of the delay circuit 537 will be described with reference to FIG. 12 hereinbelow.

FIGS. 10 through 12 are graphs illustrating operations of an LED driving device according to an exemplary embodiment of the present disclosure.

FIG. 10 is a graph illustrating an operation of the LED driving device 500 when the AC voltage Vin supplied to the LED driving device 500 is higher than the first reference voltage V₁. Referring to FIG. 10, a level of the voltage V_{C} may be increased as a level of the AC voltage Vin is increased, and when the level of the voltage V_{C} is higher than the first reference voltage V₁, a driving voltage V_{D} may be supplied to the operational amplifier U1 starting from time t1, such that the operational amplifier U1 may output a HIGH signal. Since the output from the operational amplifier U1 is changed to HIGH, the OR gate U3 also outputs a HIGH signal to turn on the switching element Q3, allowing a current to flow to the inductor LQ1, and thus, the switching element Q1 of the capacitor bank 510 is turned on. Since the capacitor C1 having a relatively high capacitance value is connected between the input terminals A and B, a voltage gain of the transformer 13 may be reduced, and as the level of the AC voltage Vin is lowered, the voltage V_{C} may be reduced to be lower than the reference voltage V₁.

When the voltage V_{C} is lower than the first reference voltage V₁, the output from the operational amplifier U1 may be changed from HIGH to LOW. However, since one of the input terminals of the OR gate U3 connected to the output terminal of the operational amplifier U1 receives feedback of its output, the output of the OR gate U3 may be constantly maintained as HIGH. The switching element Q3 may therefore be maintained in the turned-on state, and the switching element Q1 of the capacitor bank 510 may be kept to be turned on; thus, the capacitor C1 may be maintained in a connected state.

Without a latch circuit, that is, without the OR gate U3, when the output of the operational amplifier U1 changes from HIGH to LOW, the switching element Q3 may be turned off. Thus, the current flowing to the inductor LQ1 may be cut off and the switching element Q1 may also be turned off. Since the connection of the capacitor C1 is released, the voltage gain of the transformer 13 may be increased again and the AC voltage Vin having a high level may be applied to render the voltage V_{C} to be higher than the first reference voltage V₁, and thus, the output of the operational amplifier U1 may be changed from LOW to HIGH. This operation may be iteratively performed. As a result, by connecting the latch circuit to the output terminal of the operational amplifier U1, such an iterative operation may be prevented and the AC voltage Vin having a stable level may be controlled to be continuously applied to the LED driving device 500 even after a time t2.

FIG. 11 is a graph illustrating an operation of the LED driving device 500 in a case in which a level of the AC voltage Vin supplied to the LED driving device 500 is lower than the second reference voltage V₂. Referring to FIG. 11, when the level of the voltage V_{C} determined by the level of the AC voltage Vin is lower than the second reference voltage V₂, the driving voltage V_{D} may be supplied to the operational amplifier U2 after a time t1 such that the operational amplifier U2 may output a HIGH signal. As the output of the operational amplifier U2 is changed to HIGH, the OR gate U4 may also output a HIGH signal, the switching element Q4 may be turned on, and a current may flow to the inductor LQ2; thus, the switching element Q2 of the capacitor bank 510 may be turned on. Since the capacitor C2 having a relatively low capacitance value is connected between the input terminals A and B, the voltage gain of the transformer 13 may be increased and the level of the AC voltage Vin may also be increased to render the voltage V_{C} to be higher than the second reference voltage V₂.

When the voltage V_{C} is higher than the second reference voltage V₂, the output of the operational amplifier U2 may be changed from HIGH to LOW. However, since one of the input terminals of the OR gate U4 connected to the output terminal of the operational amplifier U2 receives feedback of its output, the output of the OR gate U4 may be constantly maintained as HIGH, the switching element Q4 may thus be maintained in the turned-on state, and the switching element Q2 of the capacitor bank 510 may be kept to be turned on; thus, the capacitor C2 may be maintained in a connected state.

Without a latch circuit, that is, without the OR gate U4, the output of the operational amplifier U2 may be changed from HIGH to LOW when the input voltage increases and causes the voltage V_{C} to exceed the threshold V_{C}, such that the switching element Q4 is turned off,. As a result, the current flowing to the inductor LQ2 may be cut off and the switching element Q2 may also be turned off. Since the connection of the capacitor C2 is released, the voltage gain of the transformer 13 may be reduced again and the AC voltage Vin having a low level may be applied to render the voltage V_{C} to be lower than the second reference voltage V₂, and thus, the output of the operational amplifier U2 may be changed from LOW to HIGH. This operation may be iteratively performed. As a result, by connecting the latch circuit U4 to the output terminal of the operational amplifier U2, such an iterative operation may be prevented and the AC voltage Vin having a stable level may be controlled to be continuously applied to the LED driving device 500 even after the time t2.

In FIGS. 10 and 11, the time t1 corresponds to a timing at which the driving voltage V_{D} starts to be applied to the operational amplifiers U1 and U2. That is, the operational amplifiers U1 and U2 do not start operating simultaneously at a point in time at which the AC voltage Vin is applied. Instead, after the delay time t1 which is determined by a capacitance value of the capacitor C3 included in the delay circuit 537 has lapsed, the operational amplifiers U1 and U2 begin operation on the driving voltage V_{D} applied to their inputs. This delay time may be aimed at preventing occurrence of a malfunction that may occur as at least one of the capacitors C1 and C2 included in the capacitor bank 510 is connected to the input terminals A and B in a case in which the AC voltage Vin, enabling the LED driving device 500 to operate normally, is supplied. This will be described with reference to FIG. 12 as follows.

FIG. 12 is a graph illustrating an operation in a case in which the AC voltage Vin applied to the LED driving device 500 has a level lower than the first reference voltage V₁ and higher than the second reference voltage V₂. Since the level of the AC voltage Vin is lower than the first reference voltage V₁ as an upper limit reference for securing a stable operation of the light emitting unit 15 and higher than the second reference voltage V₂ as a lower limit reference, the controller 530 may not control the capacitor bank 510 to adjust a voltage gain of the transformer 13.

Referring to FIG. 12, the AC voltage Vin may be applied as the LED driving device 500 starts to operate, and the voltage V_{C} detected by the detecting circuit 533 may be gradually increased as the capacitors C4 and C5 become charged. While the voltage V_{C} may be lower than the second reference voltage V2 before the time t1, the second comparing circuit 535 may not operate before the time t1.

That is, if the voltage V_{C} is increased but does not reach the second reference voltage V₂ during initial driving (i.e., by the time t1 is reached), the controller 530 may determine that the level of the AC voltage Vin is lower than the lower limit reference V₂ and connect the capacitor C2 included in the capacitor bank 510 between the input terminals A and B. In this case, a voltage gain of the transformer 13 may be increased by the capacitor C2 to render a magnitude of the AC voltage Vin to be greater than the first reference voltage V₁. In response to the voltage V1 exceeding the first reference voltage V₁, the first comparing circuit 534 may operate to reduce the voltage gain of the transformer 13. This may result in malfunction of the LED driving device 500. More generally, operational efficiency of the LED driving device 500 may be degraded due to an unnecessary operation of the controller 530.

Thus, in the present exemplary embodiment, the delay circuit 537 may be disposed in the controller 530 to solve the aforementioned problem. The delay circuit 537 may include the capacitor C3 charged upon receiving a constant voltage supply voltage Vcc and operational amplifiers U5 and U6 operating as Schmitt trigger circuits based on a voltage across the capacitor C3. The output voltage V_{D} of the delay circuit 537 may be applied as an operating voltage to the operational amplifiers U1 and U2 included in the first and second comparing circuits 534 and 535, respectively.

In the delay circuit 537, the operational amplifier U5 operating as a Schmitt trigger circuit may output a LOW signal until a voltage of the capacitor C3 reaches a reference voltage of the Schmitt trigger circuit as the capacitor C3 is charged with electric charges. Namely, when a condition in which the voltage of the capacitor C3 is higher than the reference voltage of the Schmitt trigger circuit is satisfied, the operating voltage V_{D} may be supplied to the first and second comparing circuits 534 and 535 through the delay circuit 537. A duration of time (i.e., t2 in FIG. 12) taken for the delay circuit 537 to supply the operating voltage V_{D} to the first and second comparing circuits 534 and 535 may be determined by the capacitor C3, and the capacitor C3 may be set to have an appropriate value to prevent malfunction of the LED driving device that may occur in the process of increasing the AC voltage Vin during initial driving. In one example, the capacitor C3 is set to have a capacitance such that the delay of the delay circuit 537 is set to the duration of time (e.g., t2 in FIG. 12) taken for the operational amplifiers U1 and U2 included in the first and second comparing circuits 534, 535 to start operating and outputting a voltage higher than the second reference voltage.

FIG. 13 is a block diagram schematically illustrating a lighting system according to an exemplary embodiment of the present disclosure.

Referring to FIG. 13, a lighting system 1000 according to an exemplary embodiment of the present disclosure may include a sensor module 1010, a controller 1020, an LED driver 1030, and a light emitting unit 1040.

The sensor module 1010 may be installed indoors or outdoors, and may have a temperature sensor 1011 and a humidity sensor 1012 to measure at least one air condition among ambient temperature and humidity. The sensor module 1010 delivers the measured temperature and humidity to the controller 1020 electrically connected thereto.

The controller 1020 may compare the measured air temperature and humidity with air conditions (temperature and humidity ranges) previously set by a user, and determine a color temperature of light to be emitted by the light emitting unit 1040 based on the air condition. The controller 1020 may be electrically connected to the LED driver 1030 and control the LED driver 1030 to drive the light emitting unit 1040 at the determined color temperature.

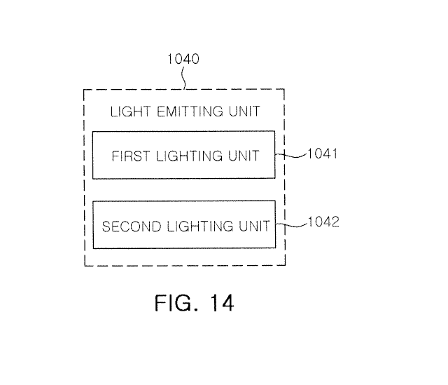

The light emitting unit 1040 operates through power supplied by the LED driver 1030. The light emitting unit 1040 may include at least one lighting device such as one of the devices illustrated in FIGS. 14 to 16. For example, as illustrated in FIG. 14, the light emitting unit 1040 may include a first lighting unit 1041 and a second lighting unit 1042 having different color temperatures, and the lighting units 1041 and 1042 may each include a plurality of light emitting devices emitting the same white light.

The first lighting unit 1041 may emit white light having a first color temperature, and the second lighting unit 1042 may emit white light having a second color temperature, where the first color temperature may be lower than the second color temperature. Conversely, the first color temperature may be higher than the second color temperature. Here, white color having a relatively low color temperature corresponds to a warmer white color, and white color having a relatively high color temperature corresponds to a colder white color. When power is supplied to the first and second lighting units 1041 and 1042, the first and second lighting units 1041 and 1042 emit white light having first and second color temperatures, respectively. The white light respectively produced by the first and second lighting units 1041 and 1042 may be mixed to implement white light having a color temperature determined by the controller 1020 based on the relative power supplied to each of the first and second lighting units 1041 and 1042.

In detail, in a case in which the first color temperature is lower than the second color temperature, if the color temperature determined by the controller 1020 is relatively high, an amount of light from the first lighting unit 1041 may be reduced and an amount of light from the second lighting unit 1042 may be increased to implement mixed white light having the determined color temperature. Conversely, when the determined color temperature is relatively low, an amount of light from the first lighting unit 1041 may be increased and an amount of light from the second lighting unit 1042 may be reduced to implement white light having the determined color temperature. Here, the amount of light emitted from each of the lighting units 1041 and 1042 may be controlled by regulating an amount of power supplied from the LED driver 1030 to the entirety of light emitting devices in the lighting unit or by regulating the number of light emitting devices in the lighting unit that are being driven.

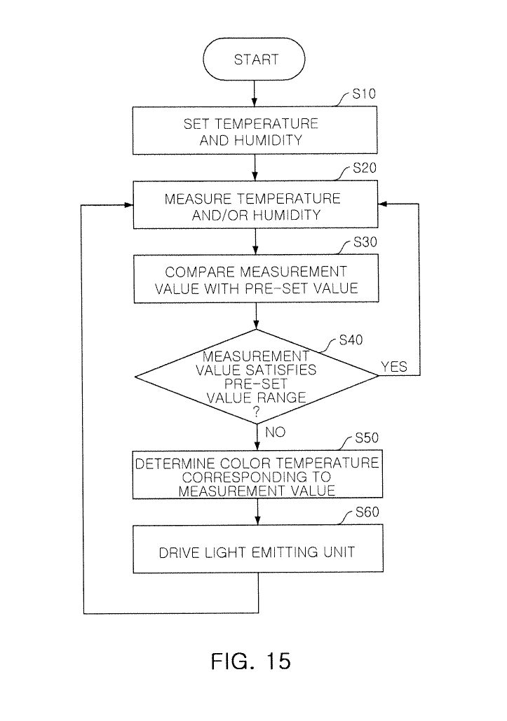

FIG. 15 is a flowchart illustrating a method of controlling the lighting system of FIG. 13. Referring to FIG. 15, the user first sets a lighting characteristic (e.g., a color temperature) according to temperature and humidity ranges through the controller 1020 (S10). The set temperature and humidity data are stored in the controller 1020.

In general, when a color temperature is higher than or equal to 6000K, a color providing a cool feeling such as blue may be produced, and when a color temperature is lower than 4000K, a color providing a warm feeling such as red may be produced. Thus, in the present exemplary embodiment, when temperature and humidity exceed 20° C. and 60%, respectively, the user may set the light emitting unit 1040 to be turned on to have a color temperature higher than 6000K through the controller 1020; when the temperature and humidity range from 10° C. to 20° C. and 40% to 60%, respectively, the user may set the light emitting unit 1040 to be turned on to have a color temperature ranging from 4000K to 6000K; and when the temperature and humidity are lower than 10° C. and 40%, respectively, the user may set the light emitting unit 1040 to be turned on to have a color temperature lower than 4000K.

Next, the sensor module 1010 measures at least one condition among ambient temperature and humidity (S20). The temperature and/or humidity measured by the sensor module 1010 are delivered to the controller 1020.

Subsequently, the controller 1020 compares the measurement value(s) delivered from the sensor module 1010 with pre-set values (S30). Here, the measurement value(s) is/are temperature and/or humidity data measured by the sensor module 1010, and the set values are temperature and/or humidity data which have been set by the user and stored in the controller 1020 in advance. The controller 1020 compares the measured temperature and/or humidity with the pre-set temperature and humidity, respectively.

According to the comparison results, the controller 1020 determines whether the measurement value(s) satisfies (y) the pre-set ranges (S40). When the measurement value(s) satisfies (y) the pre-set values, the controller 1020 maintains a current color temperature, and processing returns to step S20 to again measure the temperature and/or humidity. Meanwhile, when the measurement value(s) does/do not satisfy the pre-set values, the controller 1020 detects pre-set values corresponding to the measurement value(s), and determines a corresponding color temperature (S50). The controller 1020 controls the LED driver 1030 to drive the light emitting unit 1040 at the determined color temperature.

Then, the LED driver 1030 drives the light emitting unit 1040 to have the determined color temperature (S60). The LED driver 1030 supplies the power required to drive the light emitting unit 1040 to implement the predetermined color temperature. Accordingly, the light emitting unit 1040 may be adjusted to have a color temperature corresponding to the temperature and humidity previously set by the user according to ambient temperature and humidity measurements.

In this manner, the lighting system 1000 is able to automatically regulate a color temperature of the indoor lighting according to changes in ambient temperature and humidity, thereby satisfying human emotional needs varying according to changes in the surrounding natural environment and providing psychological stability.

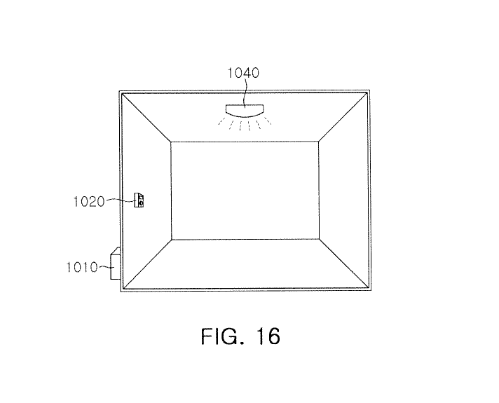

FIG. 16 is a view schematically illustrating an application of the lighting system of FIG. 13. As illustrated in FIG. 16, the light emitting unit 1040 may be installed on the ceiling of a room to function as an indoor lamp. Here, the sensor module 1010 may be implemented as a separate device and installed on an external wall in order to measure outdoor temperature and humidity. The controller 1020 may be installed in an indoor area to allow the user to easily perform setting and ascertainment operations. The lighting system is not limited thereto, but may be installed on the wall in place of an interior illumination device or may be applied to a lamp, such as a desk lamp that can be used indoors and/or outdoors.

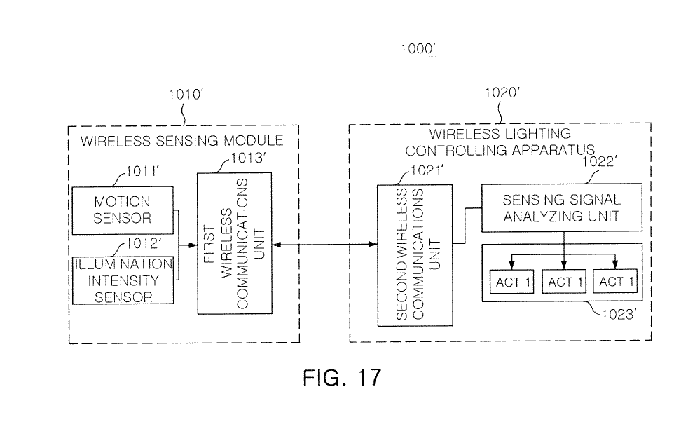

Hereinafter, another example of a lighting system using the foregoing lighting device will be described with reference to FIGS. 17 through 20. The lighting system according to the present exemplary embodiment may automatically perform a predetermined control by detecting a motion of a monitored target and an intensity of illumination at a location of the monitored target.

FIG. 17 is a block diagram of a lighting system according to another exemplary embodiment of the present disclosure.

Referring to FIG. 17, a lighting system 1000′ according to the present exemplary embodiment may include a wireless sensing module 1010′ and a wireless lighting controlling apparatus 1020′.

The wireless sensing module 1010′ may include a motion sensor 1011′, an illumination intensity sensor 1012′ sensing an intensity of illumination, and a first wireless communications unit 1013′ generating a wireless signal including a motion sensing signal from the motion sensor 1011′ and an illumination intensity sensing signal from the illumination intensity sensor 1012′ and complying with a predetermined communications protocol, and transmitting the same. The first wireless communications unit 1013′ may include a first ZigBee communications unit generating a ZigBee signal compliant with a predetermined communications protocol and transmitting the same.

The wireless lighting controlling apparatus 1020′ may include a second wireless communications unit 1021′ receiving the wireless signal from the first wireless communications unit 1013′ and restoring a sensing signal retrieved from the received wireless signal, a sensing signal analyzing unit 1022′ analyzing the sensing signal from the second wireless communications unit 1021′, and an operation controller 1023′ performing a predetermined control based on analysis results from the sensing signal analyzing unit 1022′. The second wireless communications unit 1021′ may be configured as a second ZigBee communications unit receiving the ZigBee signal from the first ZigBee communications unit and restoring a sensing signal therefrom.

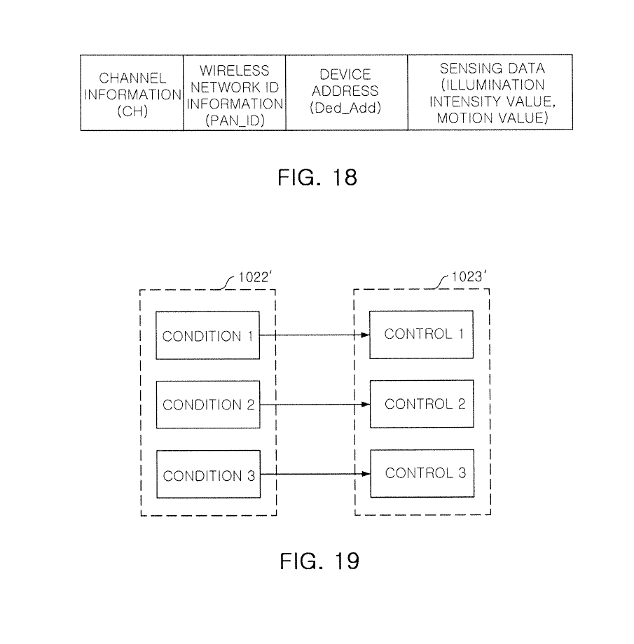

FIG. 18 is a view illustrating a format of a wireless signal such as a ZigBee signal according to an exemplary embodiment of the present disclosure.

Referring to FIG. 18, the wireless signal from the first wireless communications unit 1013′ may be a ZigBee signal and include channel information (CH) defining a communications channel, wireless network identification (ID) information (PAN_ID) defining a wireless network, a device address (Ded_Add) designating a target device, and sensing data including the motion and/or illumination intensity sensing signal.

Also, the wireless signal from the second wireless communications unit 1021′ may be a ZigBee signal and include channel information (CH) defining a communications channel, wireless network identification (ID) information (PAN_ID) defining a wireless network, a device address (Ded_Add) designating a target device, and sensing data including the motion and illumination intensity sensing signal.

The sensing signal analyzing unit 1022′ may analyze the sensing signal received from the second wireless communications unit 1021′ to detect a satisfied condition, among a plurality of conditions, based on the sensed motion and the sensed intensity of illumination information.

Here, the operation controller 1023′ may set a plurality of controls based on the plurality of conditions previously analyzed by the sensing signal analyzing unit 1022′, and perform a control corresponding to the condition detected by the sensing signal analyzing unit 1022′.

FIG. 19 is a view illustrating operation of the sensing signal analyzing unit 1022′ and the operation controller 1023′ according to the exemplary embodiment of the present disclosure. Referring to FIG. 19, for example, the sensing signal analyzing unit 1022′ may analyze the sensing signal from the second wireless communications unit 1021′ and detect a satisfied condition among first, second, and third conditions (condition 1, condition 2, and condition 3), based on the sensed motion and sensed intensity of illumination information.

The operation controller 1023′ may set one of first, second, and third controls (control 1, control 2, and control 3) corresponding to the first, second, or third conditions (condition 1, condition 2, and condition 3) previously determined by the sensing signal analyzing unit 1022′, and perform a control corresponding to the condition detected by the sensing signal analyzing unit 1022′.

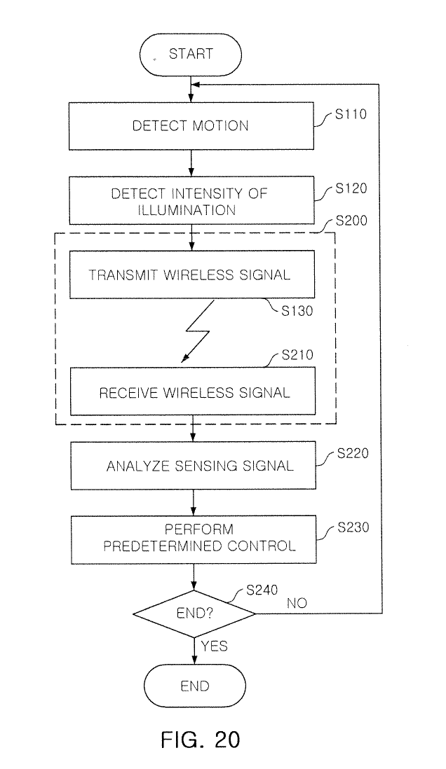

FIG. 20 is a flowchart illustrating an operation of a wireless lighting system according to an exemplary embodiment of the present disclosure.

Referring to FIG. 20, in operation S110, the motion sensor 1011′ detects a motion. In operation S120, the illumination intensity sensor 1012′ detects an intensity of illumination. Operation S200 is a process of transmitting and receiving a wireless signal such as a ZigBee signal, and may include operation S130 of transmitting a wireless signal (e.g., a ZigBee signal) by the first wireless communications unit 1013′ and operation S210 of receiving the wireless signal by the second wireless communications unit 1021′. In operation S220, the sensing signal analyzing unit 1022′ analyzes the sensing signal information included in the received wireless signal. In operation S230, the operation controller 1023′ performs a predetermined control. In operation S240, it is determined whether the lighting system control should be terminated or continued (e.g., by returning to step S110).

Operations of the wireless sensing module and the wireless lighting controlling device according to an exemplary embodiment of the present disclosure will be described with reference to FIGS. 17 through 20.

First, the wireless sensing module 1010′ of the wireless lighting system according to an exemplary embodiment of the present disclosure will be described with reference to FIGS. 17, 18, and 20. The wireless lighting system 1010′ according to the present exemplary embodiment is installed in a location in which a lighting device is installed, and used for detecting a current intensity of illumination of the lighting device and human motion near the lighting device.

The motion sensor 1011′ of the wireless sensing module 1010′ is configured as an infrared sensor, or the like, capable of sensing a human. The motion sensor 1010′ senses a motion and provides the same to the first wireless communications unit 1013′ (S110 in FIG. 20). The illumination intensity sensor 1012′ of the wireless sensing module 1010′ senses an intensity of illumination and provides the same to the first wireless communications unit 1013′ (S120).

Accordingly, the first wireless communications unit 1013′ generates a wireless signal (e.g., a ZigBee signal) including the motion sensing signal from the motion sensor 1010′ and the illumination intensity sensing signal from the illumination intensity sensor 1012′ and complying with a predetermined communications protocol (e.g., a ZigBee protocol), and transmits the generated signal wirelessly (S130).

Referring to FIG. 18, the wireless signal transmitted from the first wireless communications unit 1013′ may include channel information (CH) defining a communications channel, wireless network identification (ID) information (PAN_ID) defining a wireless network, a device address (Ded_Add) designating a target device, and sensing data. The sensing data includes a motion value and an illumination intensity value.

Next, the wireless lighting controlling apparatus 1020′ of the wireless lighting system according to an exemplary embodiment of the present disclosure will be described with reference to FIGS. 17 through 20. The wireless lighting controlling apparatus 1020′ of the wireless lighting system according to the present exemplary embodiment may control a predetermined operation according to an illumination intensity value and a motion value included in a wireless signal received from the wireless sensing module 1010′.

The second wireless communications unit 1021′ of the wireless lighting controlling apparatus 1020′ according to the present exemplary embodiment receives the wireless signal (e.g., ZigBee signal) from the first wireless communications unit 1013′, retrieves or restores a sensing signal therefrom, and provides the retrieved/restored sensing signal to the sensing signal analyzing unit 1020′ (S210 in FIG. 20).

Referring to FIG. 18, the wireless signal (e.g., ZigBee signal) from the second wireless communications unit 1021′ may include channel information (CH) defining a communications channel, wireless network identification (ID) information (PAN_ID) defining a wireless network, a device address (Ded_Add) designating a target device, and sensing data. A wireless network may be identified based on the channel information (CH) and the wireless network ID information (PAN_ID), and a sensed device may be recognized based on the device address. The sensing data includes a motion value and an illumination intensity value.

Also, referring to FIG. 17, the sensing signal analyzing unit 1022′ analyzes the illumination intensity value and the motion value included in the sensing signal from the second wireless communications unit 1021′ and provides the analysis results to the operation controller 1023′ (S220 in FIG. 20).

Accordingly, the operation controller 1023′ may perform a predetermined control according to the analysis results from the sensing signal analyzing unit 1022′ (S230).

The sensing signal analyzing unit 1022′ may analyze the sensing signal from the second wireless communications unit 1021′ and detect a satisfied condition, among a plurality of conditions, based on the sensed motion and intensity of illumination. Here, the operation controller 1023′ may store a plurality of controls corresponding to the plurality of conditions set in advance by the sensing signal analyzing unit 1022′, and perform the one control from the plurality of controls that corresponds to the condition detected by the sensing signal analyzing unit 1022′.

For example, referring to FIG. 19, the sensing signal analyzing unit 1022′ may detect a satisfied condition among the first, second, and third conditions (condition 1, condition 2, and condition 3) based on the sensed motion and intensity of illumination by analyzing the sensing signal from the second wireless communications unit 1021′.

In this case, the operation controller 1023′ may store first, second, and third controls (control 1, control 2, and control 3) respectively corresponding to the first, second, and third conditions (condition 1, condition 2, and condition 3) set in advance by the sensing signal analyzing unit 1022′, and perform a control corresponding to the condition detected by the sensing signal analyzing unit 1022′.

For example, when the first condition (condition 1) corresponds to a case in which human motion is sensed at a front door and an intensity of illumination at the front door is not low, the first control may turn off all pre-set lamps. When the second condition (condition 2) corresponds to a case in which human motion is sensed at the front door and an intensity of illumination at the front door is low, the second control may turn on a part of pre-set lamps (for example, a part of lamps at the front door and a part of lamps in a living room). When the third condition (condition 3) corresponds to a case in which human motion is sensed at the front door and an intensity of illumination at the front door is very low, the third control may turn on all the pre-set lamps.

Unlike the foregoing cases, besides the operation of turning the lamps on or off, the first, second, and third controls may be variously applied according to pre-set operations. For example, the first, second, and third controls may be associated with operations of a lamp and an air-conditioner during the summer or with operations of a lamp and heating during the winter.

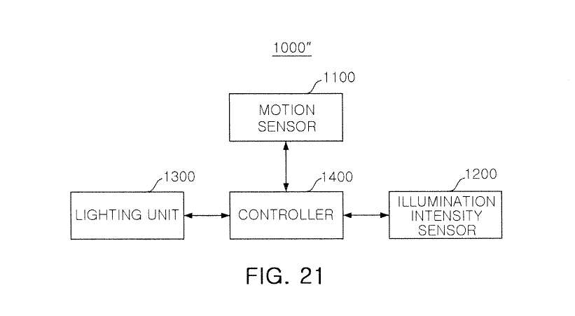

Other examples of a lighting system will be described with reference to FIGS. 21 through 24.

FIG. 21 is a block diagram schematically illustrating elements of a lighting system according to another exemplary embodiment of the present disclosure. A lighting system 1000″ according to the present exemplary embodiment may include a motion sensor 1100, an illumination intensity sensor 1200, a lighting unit 1300, and a controller 1400.

The motion sensor 1100 senses its own motion. For example, the lighting system may be attached to a movable object, such as a container or a vehicle, and the motion sensor 1100 senses a motion of the moving object. When the motion of the object to which the lighting system is attached is sensed, the motion sensor 1100 outputs a signal to the controller 1400 and the lighting system is activated. The motion sensor 1100 may include an accelerometer, a geomagnetic sensor, or the like.

The illumination intensity sensor 1200, e.g. a type of optical sensor, measures an intensity of illumination of a surrounding environment. When the motion sensor 1100 senses the motion of the object to which the lighting system is attached, the illumination intensity sensor 1200 is activated according to a signal output by the controller 1400. The lighting system illuminates during night work or in a dark environment to call a worker or an operator's attention to their surroundings, and allows a driver to secure visibility at night. Thus, even when the motion of the object to which the lighting system is attached is sensed, if an intensity of illumination higher than a predetermined level is secured (e.g., during the day), illumination of the lighting system is not required. Also, even in the daytime, if it rains, the intensity of illumination may be fairly low, so there is a need to inform a worker or an operator about a movement of a container, and the light emitting unit may thus be required to emit light. Thus, whether to turn on the lighting unit 1300 is determined by an illumination intensity value measured by the illumination intensity sensor 1200.

The illumination intensity sensor 1200 measures an intensity of illumination of the surrounding environment and outputs the measured value to the controller 1400. Meanwhile, when the illumination intensity value is greater than or equal to a pre-set value, the lighting unit 1300 is not required to emit light, and the overall system is terminated.

When the illumination intensity value measured by the illumination intensity sensor 1200 is lower than the pre-set value, the lighting unit 1300 emits light. The worker or the operator may recognize the light emitted from the lighting unit 1300 to recognize the movement of the container, or the like. As the lighting unit 1300, the foregoing lighting device may be used.

Also, the lighting unit 1300 may adjust an intensity of light emitted therefrom according to the illumination intensity value of the surrounding environment. When the illumination intensity value of the surrounding environment is low, the lighting unit 1300 may increase the intensity of light emitted therefrom, and when the illumination intensity value of the surrounding environment is relatively high, the lighting unit 1300 may decrease the intensity of light emitted therefrom, thus preventing power wastage.

The controller 1400 controls the motion sensor 1100, the illumination intensity sensor 1200, and the lighting unit 1300 overall. When the motion sensor 1100 senses the motion of the object to which the lighting system is attached, and outputs a signal to the controller 1400, the controller 1400 outputs an operation signal to the illumination intensity sensor 1200. The controller 1400 receives an illumination intensity value measured by the illumination intensity sensor 1200 and determines whether to turn on the lighting unit 1300.

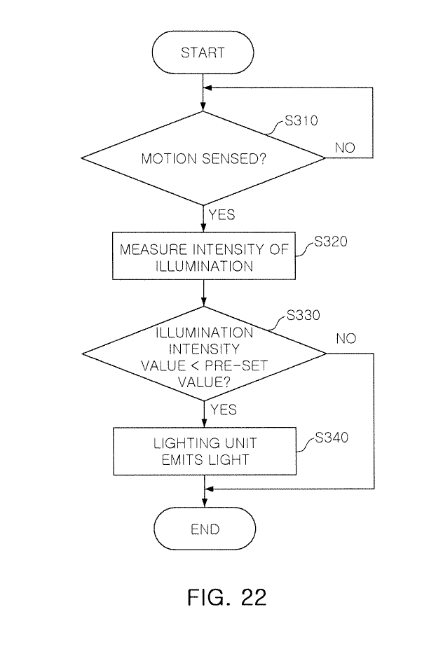

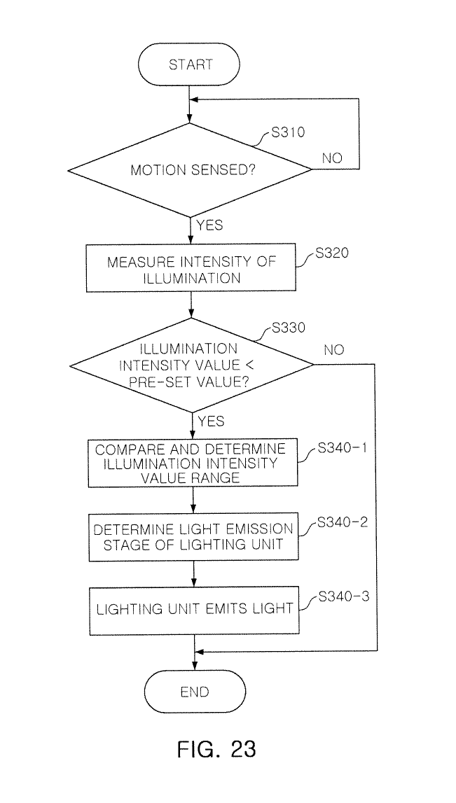

FIG. 22 is a flowchart illustrating a method of controlling a lighting system. Hereinafter, a method of controlling a lighting system will be described with reference to FIG. 22.

First, a motion of an object to which the lighting system is attached is sensed and an operation signal is output (S310). For example, the motion sensor 1100 may sense a motion of a container or a vehicle in which the lighting system is installed, and when the motion of the container or the vehicle is sensed, the motion sensor 1100 outputs an operation signal. The operation signal may be considered a signal for activating overall power of the lighting system. When the motion of the container or the vehicle is sensed, the motion sensor 1100 outputs the operation signal to the controller 1400.

Next, based on the operation signal, an intensity of illumination of a surrounding environment is measured and an illumination intensity value is output (S320). When the operation signal is transmitted to the controller 1400, the controller 1400 outputs a signal to the illumination intensity sensor 1200, and the illumination intensity sensor 1200 measures the intensity of illumination of the surrounding environment. The illumination intensity sensor 1200 then outputs the measured illumination intensity value of the surrounding environment to the controller 1400. Thereafter, whether to turn on the light emitting unit is determined according to the illumination intensity value and the light emitting unit is controlled to emit light according to the determination.

First, the illumination intensity value is compared with a pre-set value for determination (S330). When the illumination intensity value is input to the controller 1400, the controller 1400 compares the received illumination intensity value with a stored pre-set value and determines whether the received value is lower than the pre-set value. Here, the pre-set value is a value for determining whether to turn on the lighting device. For example, the pre-set value may be an illumination intensity value at which a worker or a driver may have difficulty recognizing an object with naked eyes or may make a mistake, such as when the sun starts to set.

When the illumination intensity value measured by the illumination intensity sensor 1200 is greater than the pre-set value, lighting of the light emitting unit is not required, so the controller 1400 shuts down the overall system.

Meanwhile, when the illumination intensity value measured by the illumination intensity sensor 1200 is smaller than the pre-set value, lighting of the light emitting unit is required, so the controller 1400 outputs a signal to the lighting unit 1300 and the lighting unit 1300 emits light (S340).

FIG. 23 is a flowchart illustrating a method of controlling a lighting system according to another exemplary embodiment of the present disclosure. Hereinafter, a method of controlling a lighting system according to another exemplary embodiment of the present disclosure will be described. However, description of steps similar to steps of the method of controlling a lighting system described above with reference to FIG. 22 will be omitted.

As illustrated in FIG. 23, according to the present exemplary embodiment, an intensity of light emitted from the light emitting unit may be regulated according to an illumination intensity value of a surrounding environment.

As described above, the illumination intensity sensor 1200 outputs an illumination intensity value to the controller 1400 (S320). When the illumination intensity value is smaller than a pre-set value (S330), the controller 1400 determines a range of the illumination intensity value (S340-1). The controller 1400 has a subdivided range of illumination intensity value, based on which the controller 1400 determines the range subdivision of the measured illumination intensity value.

Next, when the range of the illumination intensity value is determined, the controller 1400 determines an intensity (or other lighting characteristic) of light to be emitted from the light emitting unit based on the determined range (S340-2), and accordingly, the lighting unit 1300 emits light having the determined lighting characteristic (S340-3). The intensity (or other lighting characteristic) of light emitted from the light emitting unit may be selected according to the illumination intensity value, and the illumination intensity value (or other lighting characteristic) varies according to weather, time, and the surrounding environment, so the intensity of light emitted from the light emitting unit may also be regulated. By regulating the intensity of light emitted according to the range of the illumination intensity values, power wastage may be prevented and a worker or an operator's attention may be drawn to their surroundings.

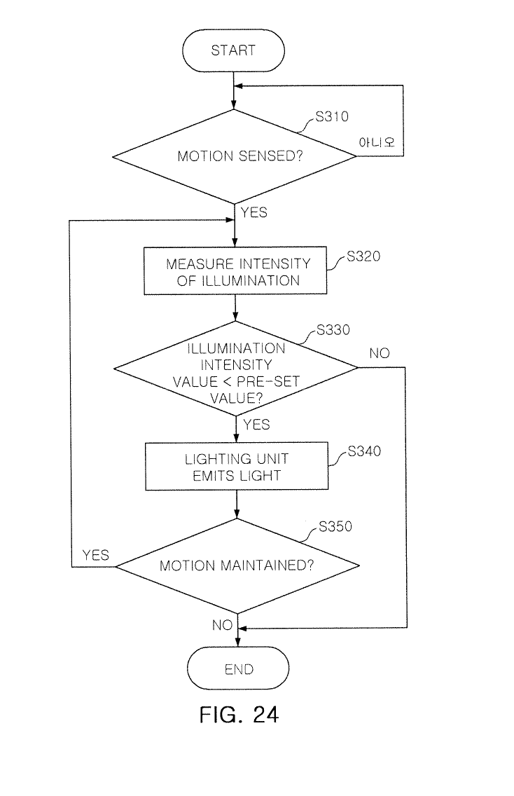

FIG. 24 is a flowchart illustrating a method of controlling a lighting system according to another exemplary embodiment of the present disclosure. Hereinafter, a method of controlling a lighting system according to another exemplary embodiment of the present disclosure will be described. However, description of steps similar to steps of the method of controlling a lighting system described above with reference to FIGS. 22 and 23 will be omitted.

The method of controlling a lighting system according to the present exemplary embodiment further includes operation S350 of determining whether a motion of an object to which the lighting system is attached is maintained while the lighting unit 1300 emits light, and determining whether to maintain light emissions.

When the lighting unit 1300 starts to emit light, termination of the light emissions may be determined based on whether a container or a vehicle to which the lighting system is installed continues to move. Here, when the motion of the container is stopped, it may be determined that an operation of the lighting system can be terminated. In addition, when a vehicle temporarily stops at a crosswalk, light emissions of the light emitting unit may be stopped to prevent interference with the vision of oncoming drivers.

When the container or the vehicle moves again, the motion sensor 1100 operates and the lighting unit 1300 may restart emitting light.

Whether to maintain light emissions may be determined based on whether a motion of an object to which the lighting system is attached is sensed by the motion sensor 1100. When the motion of the object is continuously sensed by the motion sensor 1100, an intensity of illumination is measured again (e.g., step S320) and a determination is made as to whether to maintain light emissions (e.g., step S330). When the motion of the object is not sensed (e.g., step S350 ‘NO’ branch), operation of the system is terminated for example by discontinuing light output by the lighting unit 1300.

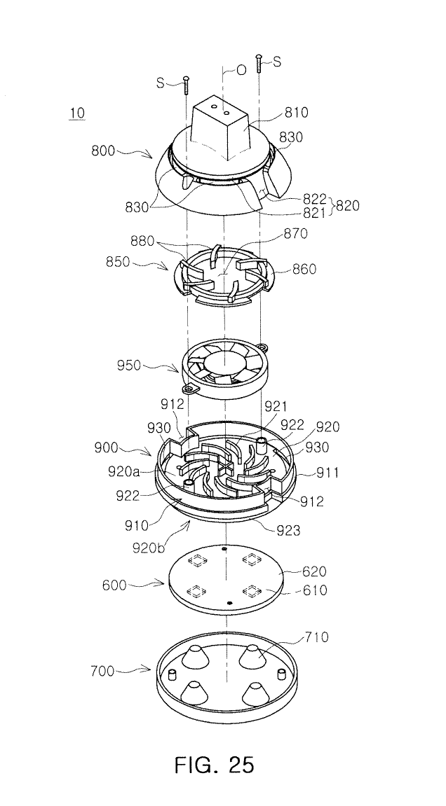

A lighting device according to an exemplary embodiment of the present disclosure will be described with reference to FIGS. 25 to 27.

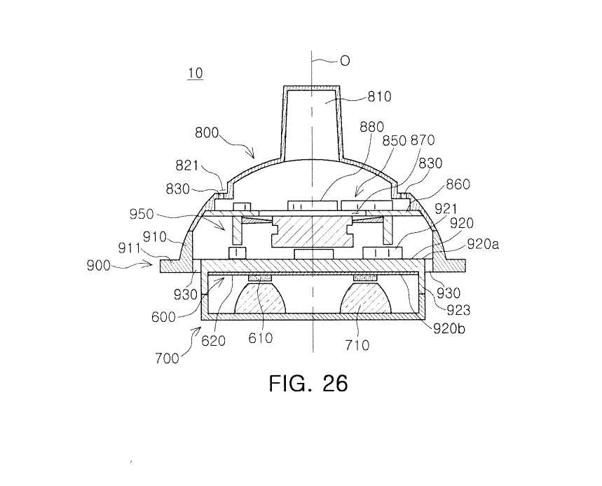

FIG. 25 is an exploded perspective view schematically illustrating a lighting device according to an exemplary embodiment of the present disclosure, and FIG. 26 is a cross-sectional view schematically illustrating a lighting device according to an exemplary embodiment of the present disclosure. In FIGS. 25 and 26, a lamp compatible with the MR16 standard is illustrated as a lighting device according to the present exemplary embodiment, but the lighting device according to an exemplary embodiment of the present disclosure is not limited thereto.

Referring to FIGS. 25 and 26, a lighting device 10 according to the present exemplary embodiment may include a base 900, a housing 800, a cooling fan 700, and a light emitting unit 600.

The base 900 is a type of a frame member in which the cooling fan 700 and the light emitting unit 600 are fixedly installed. The base 900 may include a fastening rim 910 and a support plate 920 provided within the fastening rim 910.

The fastening rim 910 may have an annular structure perpendicular with respect to a central axis O, and have a flange portion 911 protruded from a lower end portion thereof in an outward direction. When the lighting device 10 is installed in a structure such as a ceiling, the flange portion 911 may be inserted into a hole provided in the ceiling to fix the lighting device 10.

The fastening rim 910 may have a recess 912 formed to be depressed in a direction toward a central portion of the base 900. The recess 912 may have a shape corresponding to that of a flow path 820 of a housing 800 as described hereinafter, and may be formed in a position corresponding to the flow path 820. Accordingly, the flow path 820 is formed with the recess 912 in a continued manner, so as to be exposed outwards through a lower portion of the fastening film 910.

The base 900 employed in the present exemplary embodiment will be described in detail. The support plate 920 may be provided on an inner circumferential surface of the fastening rim 910 and have a horizontal structure perpendicular with respect to the central axis O and may be partially connected to the fastening rim 910. The support plate 920 may have one surface (or an upper surface) 920a and the other surface (or a lower surface) 920b both being flat and opposing each other, and may include a plurality of heat dissipation fins 921 formed on one surface 920a thereof. The plurality of heat dissipation fins 921 may be arranged radially from the center of the support plate 920 toward the edges thereof. In this case, the plurality of heat dissipation fins 921 may each have a curved surface, and have an overall spiral shape. In the present exemplary embodiment, it is illustrated that the plurality of heat dissipation fins 921 each having a curved surface are arranged in a spiral manner, but the present disclosure is not limited thereto and the heat dissipation fins 921 may have any other various shapes such as a linear shape and the like.

Fixing portions 922 may protrude to a predetermined height from the one surface 920a. The fixing portions 922 may have a screw hole formed therein to allow the housing 800 and the cooling fan 700 as described hereafter to be fixed thereto by using fixing units such as screws S, or the like.

The light emitting unit 600 is installed on the other surface 920b of the support plate 920. A side wall 923 protruding from the other surface 920b in a downward direction and having a predetermined height may be provided along the circumference of the edges. A space having a predetermined size may be provided within the side wall 923 to accommodate the light emitting unit 600 therein.

An air discharge hole 930 in the form of a slit may be provided between an outer circumferential surface of the support plate 920 and an internal surface of the fastening rim 910. The air discharge hole 930 may serve as a passage through which air is released from the one surface 920a toward the other surface 920b, such that air may not be stagnant in the one surface 920a and a continuous air flow may be maintained.

The base 900 is directly in contact with the light emitting unit 600 as a heat source, and may be made of a material having excellent heat conductivity in order to perform a heat dissipation function such as that of a heat sink. For example, the base 900 may be formed of a metal, a resin, or the like, having excellent heat conductivity through injection molding, or the like, such that the fastening rim 910 and the support plate 920 are integrated. Also, the fastening rim 910 and the support plate 920 may be manufactured as separate components and assembled. In this case, the support plate 920 may be made of a metal, a resin, or the like, having excellent heat conductivity, and the fastening rim 910 that the user directly grasps in case of an operation such as replacement of a lighting device, or the like, may be made of a material having relatively low heat conductivity in order to prevent damage due to a burn.

As illustrated in FIGS. 25 and 26, the housing 800 may be disposed on one side of the base 900. In detail, the housing 800 is fastened to the fastening rim 910, covering the support plate 920. The housing 800 may have an upwardly convex parabolic shape, and a terminal portion 810 is provided in an upper end portion of the housing 800 and fastened to an external power source (for example, a socket), and an opening may be formed in a lower end portion thereof and fastened to the base 900. In particular, the housing 800 may include the flow path 820 as a depressed region forming a step with respect to an external surface of the housing 800 to guide an inflow of air from the outside, and an air inflow hole 830 allowing air guided through the flow path 820 to be introduced to an internal surface.

The air inflow hole 830 may have an annular shape along the circumference of the housing 800 and may be adjacent to an upper end portion of the housing 800. At least one flow path 820 may have a depressed structure in the form of a recess and be formed on an outer surface of the housing 800. The flow path 820 may extend upwardly along the outer surface of the housing 800 to communicate with the air inflow hole 830.

In detail, the flow path 820 may include a first flow path 821 formed along the circumference of the housing 800 in a position corresponding to the air inflow hole 830 to communicate with the air inflow hole 830, and a second flow path 822 extending from the first flow path 821 to a lower end portion of the housing 800 to be opened outwards. The second flow path 822 may be formed with the recess 912 of the fastening rim 910 fastened to the lower end portion of the housing 800 in a continued manner, and may extend to a lower portion of the fastening rim 910 to be opened outwards. Accordingly, ambient air may be introduced along the flow path 820 as a portion of the outer surface of the housing 800 from a lower side of the fastening rim 910 and guided in an upward direction, and may be introduced to an internal space of the housing 800 through the air inflow hole 830. In the present exemplary embodiment, it is illustrated that a pair of second flow paths 822 are provided facing each other, but the number of the second flow paths 822 and positions thereof may be variously modified.

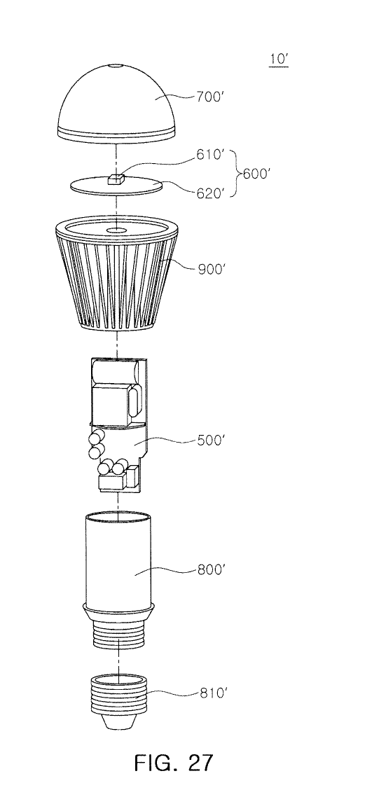

FIG. 27 is an exploded perspective view illustrating a lighting device according to an exemplary embodiment of the present disclosure.

Referring to the exploded perspective view of FIG. 27, a lighting device 10′ is illustrated as, for example, a bulb type lamp, including a light emitting unit 600′, an LED driver 500′, and an external connection unit 810′. Also, the lighting device 10′ may further include external structures such as a housing 800′ and a cover unit 700′. The light emitting unit 600′ may include a light emitting device 610′ having the LED package structure or any structure similar thereto and a board 620′ on which the light emitting device 610′ is mounted. In the present exemplary embodiment, a single light emitting device 610′ is illustrated as being mounted on the board 620′, but the present disclosure is not limited thereto and a plurality of light emitting devices 610′ may be mounted as necessary.

Heat generated by the light emitting device 610′ may be dissipated through a heat dissipation unit, and a heat sink 900′ directly in contact with the light emitting unit 600′ to enhance heat dissipation effect may be included in the lighting device 10′ according to the present exemplary embodiment. The cover unit 700′ may be installed on the light emitting unit 600′ and have a convex lens shape. The LED driver 500′ may be installed in the housing 800′ and be connected to the external connection unit 810′ having a socket structure to receive power from an external power source. Also, the LED driver 500′ may serve to convert received power into an appropriate current source for driving the light emitting device 610′ included in the light emitting unit 600′ and provide the same. For example, the LED driver 500′ may include a rectifying circuit, a DC-DC converter circuit, and the like.

Also, the lighting device 10′ may further include the communications module as described above.

The lighting device using an LED as described above may be altered in terms of an optical design thereof according to a product type, a location, and a purpose. For example, in relation to the foregoing emotional illumination, a technique for controlling lighting by using a wireless (e.g., remote) control technique utilizing a portable device such as a smartphone may be provided, in addition to a technique of controlling color, temperature, brightness, and hue of illumination.

In addition, a visible wireless communications technology aimed at simultaneously achieving a unique purpose of an LED light source and a purpose of a communications unit by adding a communications function to LED lighting devices and display devices may be available. This is because an LED light source has a longer lifespan and excellent power efficiency, implements various colors, supports a high switching rate for digital communications, and is available for digital control, in comparison with existing light sources.

The visible light wireless communications technology is a wireless communications technology transferring information wirelessly by using light having a visible light wavelength band recognizable by human eyes. The visible light wireless communications technology is distinguished from a wired optical communications technology in that it uses light having a visible light wavelength band and that a communications environment is based on a wireless scheme.

Also, unlike RF wireless communications, the visible light wireless communications technology has excellent convenience and physical security properties as it can be freely used without being regulated or needing permission in the aspect of frequency usage, is differentiated in that a user can physically check a communications link, and above all, the visible light wireless communications technology has features as a fusion technique obtaining both a unique purpose as a light source and a communications function.

As set forth above, according to exemplary embodiments of the present disclosure, a variable impedance unit is connected to an input terminal of an LED driving device driving LEDs, and impedance of the variable impedance unit may be determined based on an input voltage or output voltage of the LED driving device. Thus, a highly compatible LED driving device is provided that can be applied to halogen lamp transformers or fluorescent lamp stabilizers having various specifications. In particular, brightness of an LED may be adjusted by adjusting a voltage gain of a transformer or a stabilizer by adjusting impedance of the variable impedance unit, apart from phase controlling of a dimmer, and a heating value may be reduced, while efficiency of circuits included in the LED driving device is enhanced.

Advantages and effects of the present disclosure are not limited to the foregoing content and any other technical effects not mentioned herein may be easily understood by a person skilled in the art from the foregoing descriptions.

While exemplary embodiments have been shown and described above, it will be apparent to those skilled in the art that modifications and variations could be made without departing from the spirit and scope of the present disclosure as defined by the appended claims.

1. A light emitting diode (LED) driving device, comprising:
a rectifier configured to rectify an alternating current (AC) voltage to generate a first voltage;
a voltage converter configured to generate a second voltage for driving a plurality of LEDs based on the first voltage;
a variable impedance unit connected to an input terminal of the rectifier; and
a controller configured to adjust impedance of the variable impedance unit based on at least one of the first and second voltages.

2. The LED driving device of claim 1, wherein the controller comprises:
a detecting circuit configured to detect at least one of the first voltage and the second voltage;
a comparing circuit configured to compare the voltage detected by the detecting circuit with one or more reference voltages and adjusting the impedance of the variable impedance unit based on the comparison; and
a delay circuit configured to control an operation timing of an active element included in the comparing circuit.

3. The LED driving device of claim 2, wherein the comparing circuit comprises:
a first comparing circuit configured to compare the voltage detected by the detecting circuit with a first reference voltage; and
a second comparing circuit configured to compare the voltage detected by the detecting circuit with a second reference voltage,
wherein the first reference voltage is higher than the second reference voltage.

4. The LED driving device of claim 3, wherein when the voltage detected by the detecting circuit is higher than the first reference voltage, the comparing circuit adjusts impedance of the variable impedance unit such that a level of the AC voltage is decreased, and
when the voltage detected by the detecting circuit is lower than the second reference voltage, the comparing circuit adjusts the impedance of the variable impedance unit such that the level of the AC voltage is increased.

5. The LED driving device of claim 3, wherein the first comparing circuit and the second comparing circuit each include an operational amplifier, and
the voltage detected by the detecting circuit is applied to a non-inverting terminal of the operational amplifier included in the first comparing circuit and to an inverting terminal of the operational amplifier included in the second comparing circuit.

6. The LED driving device of claim 5, wherein the delay circuit delays an operation timing of the operational amplifiers included in the first and second comparing circuits by a predetermined duration.

7. The LED driving device of claim 6, wherein a duration by which the delay circuit delays the operation timing of the operational amplifiers included in the first and second comparing circuits is a duration taken for the operational amplifiers included in the first and second comparing circuits to start operating and outputting a voltage higher than the second reference voltage.

8. The LED driving device of claim 5, wherein the first and second comparing circuits each include a latch circuit connected to an output terminal of the operational amplifier of the corresponding comparing circuit.

9. (canceled)

10. The LED driving device of claim 1, wherein the variable impedance unit comprises a capacitor bank having a plurality of capacitors connected in parallel.

11. The LED driving device of claim 10, wherein when at least one of the first and second voltages is higher than the first reference voltage, the controller controls a capacitor having relatively large capacitance among the plurality of capacitors to be connected to the input terminals of the rectifier in parallel, and
when at least one of the first and second voltages is lower than the second reference voltage lower than the first reference voltage, the controller controls a capacitor having relatively small capacitance among the plurality of capacitors to be connected to the input terminals of the rectifier in parallel.

12-14. (canceled)

15. A lighting device, comprising:
a light emitting unit including a plurality of light emitting diodes (LEDs);
an LED driver configured to drive the plurality of LEDs upon receiving an alternating current (AC) voltage generated by at least one of a transformer for halogen lamp and a stabilizer for fluorescent lamp;
a variable impedance unit connected to an input terminal of the LED driver; and
a controller configured to adjust a level of the AC voltage input to the LED driver by controlling impedance of the variable impedance unit.

16. The lighting device of claim 15, wherein the LED driver comprises:
a rectifier configured to rectify the AC voltage to generate a first voltage; and
a voltage converter configured to generate a second voltage for driving the plurality of LEDs based on the first voltage,
wherein the variable impedance unit is connected to an input terminal of the rectifier.

17. The lighting device of claim 15, wherein when at least one of the first and second voltages is outside of a predetermined voltage range, the controller adjusts the level of the AC voltage.

18. The lighting device of claim 17, wherein when at least one of the first and second voltages is lower than a lower limit level of the predetermined voltage range, the controller adjusts impedance of the variable impedance unit such that the level of the AC voltage is increased.

19. The lighting device of claim 17, wherein when at least one of the first and second voltages is higher than an upper limit level of the predetermined voltage range, the controller adjusts impedance of the variable impedance unit such that the level of the AC voltage is decreased.

20. The lighting device of claim 16, wherein the LED driver adjusts a magnitude of the second voltage used for driving the plurality of LEDs based on a control command received via a wireless communications network.

21. A control circuit of a light emitting diode (LED) driving device driving a plurality of LEDs upon receiving an alternating current (AC) voltage, the control circuit comprising:
a detecting circuit configured to detect at least one of an input voltage and an output voltage of the LED driving device;
a comparing circuit configured to compare at least one of the input voltage and the output voltage of the LED driving device with a first reference voltage and a second reference voltage lower than the first reference voltage; and
a delay circuit configured to delay an operation timing of an active element included in the comparing circuit.

22. The control circuit of claim 21, wherein the comparing circuit comprises:
a first comparing circuit having a first operational amplifier comparing at least one of the input voltage and the output voltage of the LED driving device with the first reference voltage and a latch circuit connected to an output terminal of the first operational amplifier; and
a second comparing circuit having a second operational amplifier comparing at least one of the input voltage and the output voltage of the LED driving device with the second reference voltage and a latch circuit connected to an output terminal of the second operational amplifier.

23. The control circuit of claim 21, wherein when at least one of the input voltage and the output voltage of the LED driving device is higher than the first reference voltage, the comparing circuit lowers a level of the AC voltage, and when at least one of the input voltage and the output voltage of the LED driving device is lower than the second reference voltage, the comparing circuit raises the level of the AC voltage.

24. The control circuit of claim 23, wherein the comparing circuit raises or lowers the level of the AC voltage by adjusting a capacitance value of a capacitor bank included in the LED driving device.

25-28. (canceled)
